(19) United States
(12) Patent Application Publication
(10) Pub. No.: US 2002/0128857 A1
(43) Pub. Date: Sep. 12, 2002

(54) Method for producing identification code, and method and system for giving electronic notice service and electronic meter reading sevice by using the same

(76) Inventor: Koo Yeon Lee, Anshan-shi (KR)

Correspondence Address: James A. Flight, MARSHALL, GERSTEIN, & BORUN, 6300 Sears Tower, 233 South Wacker Drive, Chicago, IL, 60606-6402, US

(21) Appl. No.: 10/025,054

(22) Filed: Dec. 18, 2001

Related U.S. Application Data
(63) Continuation of application No. PCT/KR01/00644, filed on Apr. 18, 2001.

(30) Foreign Application Priority Data
Apr. 18, 2000 (KR) P2000-20400
Apr. 18, 2000 (KR) P2000-20399
Jun. 27, 2000 (KR) P2000-35652
Jul. 10, 2000 (KR) P2000-39361

(51) Int. Cl. G06F 17/60

(52) U.S. Cl. 705/1

(57) ABSTRACT

Method and system for producing an identification code from a postal code, an address, social security number or a state driver license number, or an enterprise registration number. and the like for delivering electronic notices on a communication network, and service method and system for giving an electronic notice, in which notices for various fees for services to persons, or taxes are given on a cyber space, such as the Internet, payment for the fees are made through the cyber space, various meter readings are made on the cyber space, and the payments are administrated, by using the method and device for producing an identification code.

### TECHNICAL FIELD

The present invention relates to communication services, and more particularly, to method and system for producing an identification (ID) code from a postal code, an address, a social security number or a state driver license number, an enterprise registration number, or the like for delivering electronic notices at the ID code on a communication network, and method and system for giving an electronic notice service, in which notices on various charges for services, or taxes are given to notice receivers on a cyber space, such as Internet, receptions of the charges are made on the cyber space, various meter readings are made on the cyber space such as Internet, and particulars of the receptions are administrated by using the above method and device for producing an ID code.

### BACKGROUND ART

In general, the notice is used for giving information on a required payment to a particular person or an address. The notice is issued from a notice issuer at fixed intervals, and received at a post office. The notices collected at the post office are sorted by areas at the post office, and delivered to local post offices. Then, the notices are sorted by addresses at the local post offices, and delivered to houses of receivers, so that the receiver receives the notices. Thus, there has been much time period required from the issuance to the delivery of the notice to the receivers, and inconvenience for the receiver to make a payment for the noticed charge. Of course, though automatic transfer services may be used, the automatic transfer services also have inconveniences in visiting, or making calls to a banking facility, such as a bank, by person, for application of the automatic transfer. Particularly, there have been many cases in which the notices are lost in the course of delivery or delivered to wrong addresses, resulting to fail making the required payment within a due date, that makes person to pay an artears or a penalty, additionally. The re-issuance and delivery of the notices following the lost or wrong delivery of the notices causes much waste both in manpower and material resources, and particularly, the wrong delivery to a wrong address may cause exposure of personal data or privacy. The entities supplying gas, electricity and water to homes require monthly meter reading, and give notices on charges for amounts of monthly use in the next month. In reading the meters, since a gas supply entity reads a gas meter only, an electricity supply entity reads an electricity meter only, and a water supply entity reads a water meter only, much manpower has been required. Recently, keeping pace with a trend of popularization of Internet, one governmental organ has provided a plan for making payment of various taxes and fees on Internet for the convenience of people, and realizing an electronic government. The plan includes payments of various taxes, penalties, school fees, pensions, insurance bills, and various public utility charges on the Internet upon request by payers. However, the plan has description neither of specific system nor of service procedures, nor overall operation. Particularly, the plan limits a range of the notices.

### DISCLOSURE OF THE INVENTION

An object of the present invention is to provide a method for producing an identification code, in which a service provider provides proper identification codes to every user from information on the user, such as a user address, a telephone number, an enterprise registration number, a social security number or a state driver license number, or the like for easy delivery of notices to every member of homes or enterprises.

Another object of the present invention is to provide method and system for giving electronic notice service and electronic meter reading service, in which, after the proper identification code is given to each user as above, a notice giving and payment reception of various fees and taxes are made on a cyber space, such as the Internet, and electronic formats for reading meters, such as gas, electricity, and water, are provided to users on an appointed date, so that the user can write up the format and transmit the format back to the provider.

Further object of the present invention is to provide method and system for giving electronic notice service, in which payments received from users are administrated by users proper identification codes and providing economic data by the proper identification codes based on the received payments.

Still another object of the present invention is to provide method and system for giving electronic notice service, in which a service provider gives proper identification codes based on user information in giving an electronic notice, and giving an ID of users preference for administrating electronic notices and received payments with reference both to the proper ID codes and the ID of the users preference.

Still further object of the present invention is to provide method and system for giving electronic notice service, in which an ID for giving an electronic notice and settlement, and an ID for advertisement are administrated separately, for giving an electronic service suitable to users preference.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the method for producing an ID code includes the steps of (1) receiving required information on a user through Internet or information stored in a storage part already, (2) producing IDs identifiable by addresses from numerals or codes used generally, universally, and socially in the received information by using ID codes fixed in advance, and (3) providing the produced ID to the user.

The required information is producing an ID code for each address from at least one selected from a postal code and actual address, a telephone number, an enterprise registration number, and a social security number, or state driver license number.

Another code is added to the produced family ID to combine the family ID and the another code, to produce personal ID for a plurality of members of the family or the enterprise.

The step (3) includes the steps of adding an advertisement or questions to the E-mail in providing the E-mail to the user.

The method for producing an ID code permits a user to select objects to be served, and to make continuous, and stable financial dealings on Internet.

In another aspect of the present invention, there is provided a method for producing an ID code including a first determining step for a service provider determining an accesser accessed to a web site of the service provider of being a user or a business connection, a step for receiving data to be transmitted to general users and storing in a storage part if the user is the business connection as a result of the determination, a second determining step for determining the accessed accesser of being a member by searching a member DB if the accessed accesser is the user as a result of the determination, a step, if the accessed accesser is determined to be a non-member, for providing an input window to the accesser, receiving required information, producing a family ID from the received information, and storing in the member DB, to register as a member, a step for searching the storage part for existence of data to be transmitted to the member if the accesser is determined to be the member as a result of the determination in the second determination step, and a step for transmitting the data through a member E-mail at a family ID stored in the member DB if the data is found as a result of the search.

The method for producing an ID code of the present invention suggests producing a family ID from a postal code, an address, a social security number or state driver license number, and an enterprise registration number, and receiving an ID of users preference, and managing the family ID and the ID of the users preference in common for transmission and reception of data by using the family ID or the ID of the users preference.

The present invention permits to replace official documents posted to homes and enterprises from the government or local autonomous entities with electronic documents on E-mail as the home/enterprise E-mail addresses are established officially according to ID codes (family ID), thereby reducing inconvenience of caused by charging and payment, and permitting wholesome housekeeping/management of an enterprise as prediction of a trend of spending and expenditure are made possible. The government or the local autonomous entities can eliminate notice posting expense, improve an administration efficiency, give information on governmental policy, and advance realization of an electronic government.

In further aspect of the present invention, there is provided a method for giving an electronic notice service including the steps of (1) a host server collecting particulars of charges of a plurality of the users (receivers) from various notice issuers, (2) calculating collected one or more of the particulars of the charges to built up a data base by receivers/due dates, (3) producing individual charge notice for the user (receiver) in an electronic document based on the data base, and (4) transmitting the electronic document to the user (receiver) at the proper ID code.

After the step (4), further including the steps of (5) as the electronic document is displayed on a computer of the receiver, the receiver viewing the charge notice and paying the charge, (6) sorting particulars of reception for the particulars of the charge notice by ID codes, to build up a data base, and (7) analyzing the data base, and providing a housekeeping book to each receiver as an economy data for each receiver.

The step (5) includes the steps of producing individual charge notice in a form of electronic document of an electronic mail, and transmitting the electronic document to an individual Internet address produced from the individual ID code.

In still further aspect of the present invention, there is provided a system for an electronic notice including a first data base for storing a proper ID code of a user produced by using a rule or an official number given arbitrarily, a second data base for storing one or more charge particulars for each user collected from various notice issuers, with the charge particulars separated by ID codes in connection with the ID codes stored in the first data base, a host server for producing Internet address for each user from the ID code stored in the first data base, producing charge particulars to the ID code stored in the second data base in an electronic document, and transmitting the electronic document to the Internet address, and a users computer for restoring charge notice particulars from the electronic document transmitted from the host server, and displaying the charge notice particulars to the user given an ID code corresponding to the Internet address.

The host server processes payments in a payment method fixed in advance by the receiver in connection with a banking facility fixed in advance as the receiver confirms the displayed charge notice particulars, and approves the payment.

The system for an electronic notice further includes a third data base for storing reception particulars after the charge is paid as the receiver approves payment for the charge notice, with the reception particulars separated by ID codes in connection with the ID codes stored in the first data base.

The host server analyzes payment reception particulars stored in the third data base, and provide the receiver with a text for suggesting the receiver a direction of economic activity.

In still another aspect of the present invention, there is provided a method for giving an electronic meter reading service, including the steps of (I) securing a plurality of users as members, and producing proper ID codes from users information, (2) collecting agreed meter reading dates and agreed meter reading particulars for a plurality of the users registered as members from various meter reading notice issuers, and building up a data base, (3) producing meter reading notice for the user in an electronic document based on the data base, and (4) transmitting the electronic document to the user at the ID code.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a block diagram of a system of a service provider for producing a family ID in accordance with a preferred embodiment of the present invention;

FIG. 2 illustrates a flow chart showing the steps of a method for producing a family ID in accordance with a preferred embodiment of the present invention;

FIG. 3A illustrates a flow chart showing the steps of a method for producing a family ID from a postal code and an actual address in accordance with a first preferred embodiment of the present invention;

FIG. 3B illustrates a flow chart showing the steps of a method for producing a family ID form a telephone number in accordance with a second preferred embodiment of the present invention;

FIG. 3C illustrates a flow chart showing the steps of a method for producing a family ID from an enterprise registration number in accordance with a third preferred embodiment of the present invention;

FIG. 3D illustrates a flow chart showing the steps of a method for producing a family ID from a postal code, an address, and a social security number or a state driver license number in accordance with a fourth preferred embodiment of the present invention;

FIG. 3E illustrates a family ID in accordance with a fourth preferred embodiment of the present invention;

FIG. 4 illustrates a block diagram of a system for providing an electronic notice service in accordance with a preferred embodiment of the present invention;

FIG. 5 illustrates data bases managed by a host server in a system for giving an electronic notice of the present invention;

FIG. 6 illustrates an example of a mail list format and an electronic notice format in a user computer in a case an electronic notice is made through an e-mail in the present invention;

FIG. 7 illustrates a flow chart showing the steps of a process for giving an electronic notice service in accordance with a preferred embodiment of the present invention;

FIGS. 8A˜8R illustrate basic screens required for providing a member registration of a user, administration of a notice receiver box, and payment administration;

FIGS. 9A˜9I illustrate basic screens required for registration of a notice issuer, and searching a notice data;

FIGS. 10A˜10O illustrate basic screens required for a service provider to make management and searching in accordance with a preferred embodiment of the present invention;

FIG. 11 illustrates a block diagram showing a system for giving an electronic meter reading service in accordance with a preferred embodiment of the present invention; and,

FIG. 12 illustrates a flow chart showing the steps of operation for giving an electronic meter reading service in accordance with a preferred embodiment of the present invention.

### BEST MODE FOR CARRYING OUT THE INVENTION

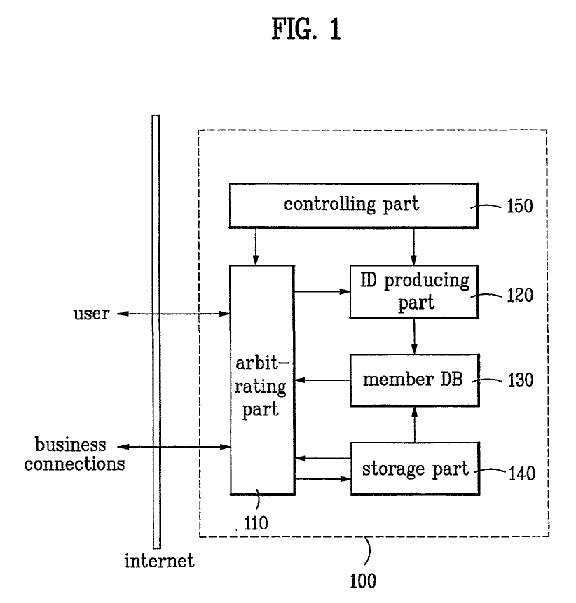

Reference will now be made in detail to the preferred embodiments of the present invention, examples of which are illustrated in the accompanying drawings. A method for producing an identification code (ID) in accordance with a preferred embodiment of the present invention will be explained. FIG. 1 illustrates a block diagram of a system of a service provider for producing a family ID in accordance with a preferred embodiment of the present invention.

Referring to FIG. 1, a system of a service provider for producing a family ID in accordance with a preferred embodiment of the present invention includes an arbitrating part 110 for interfacing and arbitrating a plurality of users and business connections in information exchange, an ID producing part 120 for producing a family ID from user information received through the arbitrating part 110 or stored already, a storage part 140 for storing data to be provided to members by using information on business connections received through the arbitrating part 110, a member DB 130 for making data bases of members and data by members in correspondence to the ID producing part 120 and the storing part 140, and a controlling part 150 for managing and controlling an entire system.

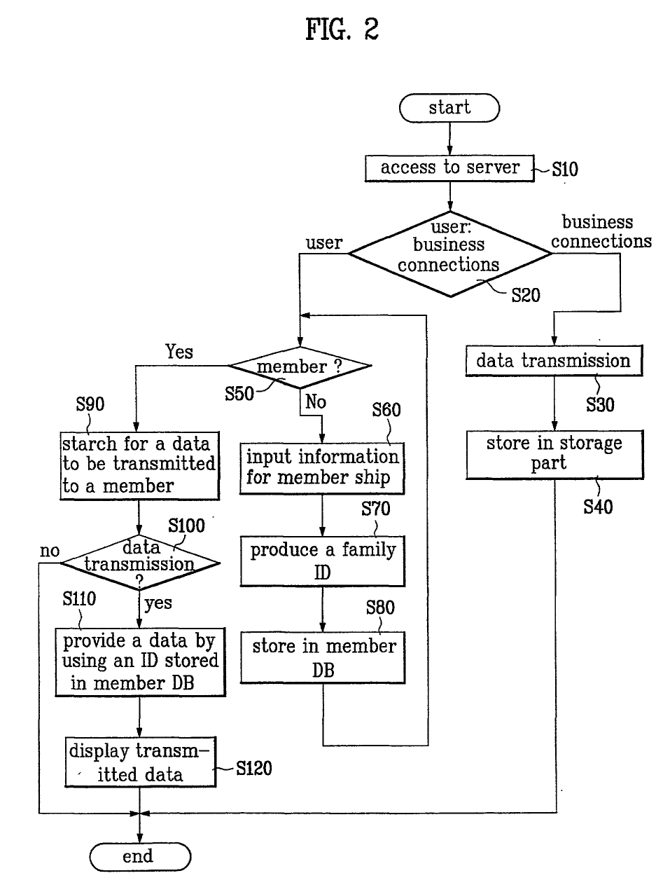

The operation of the foregoing method for producing an ID code in accordance with a preferred embodiment of the present invention will be explained. FIG. 2 illustrates a flow chart showing the steps of a method for producing a family ID in accordance with a preferred embodiment of the present invention.

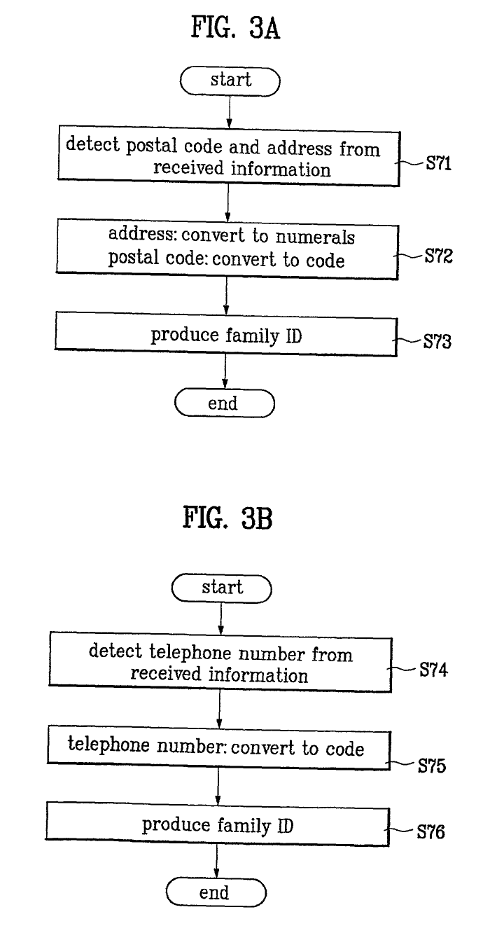

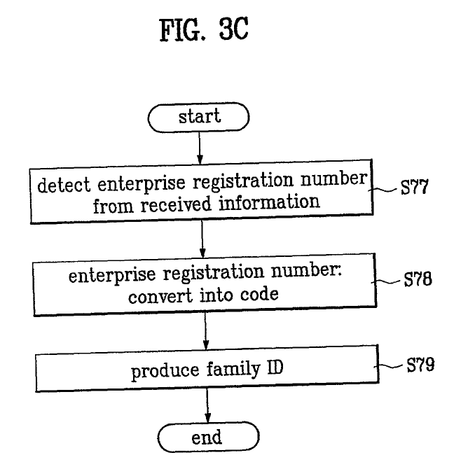

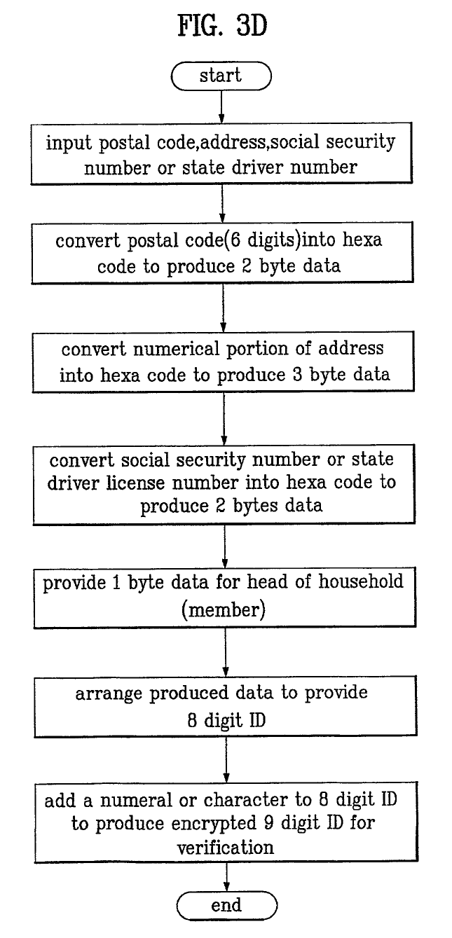

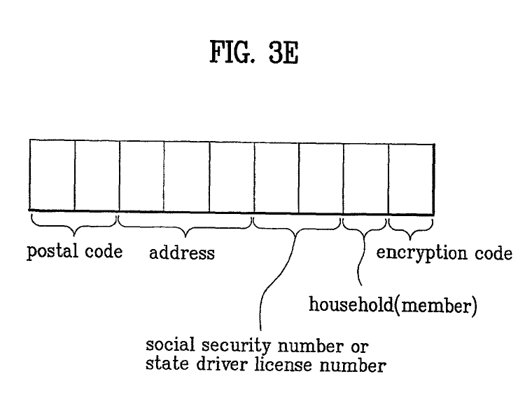

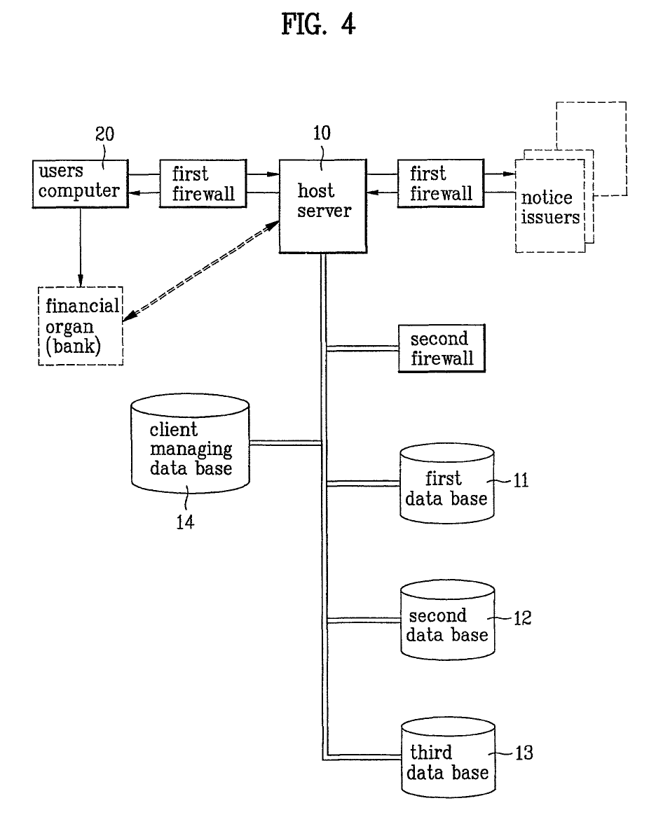

Referring to FIG. 2, the users, tax offices, a local autonomous entities, credit card companies, insurance companies, the public corporation for medical insurance, communication companies, the public corporation for city gas, the city water business headquarter, and other business connections make access to a web site provided by the service provider 100 (S10). Then, the service provider 100 determines the accesser of being a user or a business connection (S20). If the accesser is the business connection as a result of the determination, the service provider 100 receives data to be provided to users from the business connection (S30). The received data may be private auto taxes, license taxes, property taxes, general land taxes, gas charges, city water charges, medical insurance bills, pensions, auto installments, telephone charges, and the like. The service provider stores the received data in the storing part 140 (S40). If the accesser is the user as the result of the determination, the service provider 100 determines the user of being the member by searching the member DB 130 (S50). If the user is not the member as the result of determination, a procedure required for becoming the member, and information and benefits to be provided to a member, are provided to the user. After the user examines the provided information, if the user intends to become the member, the service provider 100 provides an input window for the user to input information required by the service provider 100 (S60). Then, the service provider 100 provides family IDs, IDs for each member, through the ID producing part 120 from the received information, or user information stored already (S70), produces data bases for each member, and stores in the member DB 130 (S80). The family ID is produced from numerals, or codes, used generally, universally, and socially for each address at the ID producing part 120. The numerals, or codes can be used as follows. FIG. 3A illustrates a flow chart showing the steps of a method for producing a family ID from a postal code and an actual address in accordance with a first preferred embodiment of the present invention, FIG. 3B illustrates a flow chart showing the steps of a method for producing a family ID from a telephone number in accordance with a second preferred embodiment of the present invention, FIG. 3C illustrates a flow chart showing the steps of a method for producing a family ID from an enterprise registration number in accordance with a third preferred embodiment of the present invention, FIG. 3D illustrates a flow chart showing the steps of a method for producing a family ID from a postal code, an address, and a social security number or a state driver license number in accordance with a fourth preferred embodiment of the present invention, FIG. 3E illustrates a family ID in accordance with a fourth preferred embodiment of the present invention.

Referring to FIG. 3A, the method for producing a family ID from a postal code and an actual address in accordance with a first preferred embodiment of the present invention can be used for public charge, such as tax, notices.

At first, a postal code and an address are detected from information the user provided (S71). The postal code has been used since Jul. 1, 1970 in Korea, and consists of six digits. In detail, the postal code consists of forward three digits for mail out post office and backward three digits for delivery, wherein a first digit in the forward three digits represents special or integrated municipality city/province, a second digit represents a district, and a third digit represents a city/county/ward, and a numeral in a range of 000˜599 in the backward three digits represents a village, 600˜699 represents a post box, and 700˜799 represents a large building/apartment, or a numeral in a range of 600˜900 represents a town/township. Thus, as the postal codes are given systematically under a law, the present invention suggests to encode the postal codes and to combine the encoded postal codes with actual addresses, for producing ID codes from the addresses corresponding to actual addresses (S72). In the production of ID codes for each of the addresses, the forward three digits for mailing out permit to sort out 232 cities/counties/wards all over the Korea. Accordingly, the present invention suggests to encode the entire 232 cities/counties/wards in Korea from a code system, or a character system (for example, the alphabet or numerical system) having a plurality of elements which can be inputted by using an input device, such as a computer keyboard, and represent the entire 232 cities/counties/wards. In this instance, if the English alphabet 26 characters are employed as the character system, codes that can represent the entire 232 cities/counties/wards can be produced from two characters in the alphabet (‘aa’˜‘zz’: 26²). However, because the two characters can not provide the 900 codes for the backward three digits for delivery to the villages/town (township)/post boxes/others (large buildings and apartments), three characters (‘aaa’˜‘zzz’26³) may be used for the 900 code. Then, by combining rest of the address with the coded postal code, the ID code of the present invention can be produced. In this instance, codes in the ID codes corresponding to the postal codes are fixed in advance for the entire cities/counties/wards, and villages/towns (townships)/post boxes/others (large buildings and apartments)(for an example, Gaepo village, Kangnam ward, Seoul city, may be represented with “aaa”, Gaepo village 1, Kangnam ward, Seoul city, may be represented with “aab”, Jugong apartment group 1, Gaepo village 1, may be represented with “aac”, Gaepo village 2, Kangnam ward, Seoul city, may be represented with “aad”, . . . , and Yeoksam village, Kangnam ward, Seoul city, may be represented with “abr”. The provided ID codes for the postal codes are added to a system of the present invention in a form of a look-up table. Therefore, upon reception of personal information, a postal code is detected from the personal information containing a postal code, an ID code corresponding to the postal code is read from the look-up table, and the ID code is combined with an address, to produce a desired ID code (S73). For an example, in the received personal information, when an address of the person is 101-1005, Jugong apartment group 1, Gaepo village 1, Kangnam ward, Seoul city, since “Jugong apartment group 1, Gaepo village 1, Kangnam ward, Seoul city”, with a postal code “135-770”, corresponds to “aac”, rest of the address, 101-1005, is combined with the code “aac” to produce “aac101_{—}1005” for an ID code of an address. If the address is not for an apartment, but for a house, a numeral portion of the address is combined with the ID code of the postal code, to produce an ID code for the house (for an example, “234-1, Gaepo village 1, Kangnam ward, Seoul city” may be given an ID code of “aac234-1”. Meanwhile, there may be apartments other than the “Jugong apartment group 1”, when the apartments are coded by using another characters in the alphabet (a˜z), and the apartment code is added to the ID code for the postal code, to which the numeral address is added (for an example, after Jugong apartment group is coded into ‘a’, and samick apartment is coded into ‘b’, and the like for each apartment, a numeral address, an apartment number, is added thereto to produce an ID code for a specific apartment, i.e., “101-1005, Jugong apartment group 1, Gaepo village 1, Kangnam ward, Seoul city” may have an ID code of “aaca101_{—}1005”, and “101-1005, Samick apartment, Gaepo village 1, Kangnam ward, Seoul city, may have an ID code of “aacb101_{—}1005”.

In addition to this, one digit of code may be added to the ID code for an address, for giving an ID code for each of members of a family at the address. For an example, one or more character in the alphabet or numeral is added to an end of the address ID code, to produce personal ID codes, such as “aac101_{—}1005a”, “aac101_{—}1005b”, “aac101_{—}1005c”, ----. Moreover, an Internet address, such as aac101-1005x@gucci.com (where ‘x’ denotes a character in the alphabet from ‘a’ to ‘z’ inclusive of ‘x’) may be produced based on the personal ID code, for giving an Internet address to each address, or each member of a family. If there are many members in the family or an enterprise, ID codes required for the members may be produced additionally. That is, in a case of a family, codes may be given for family members, such as 1 for father, 2 for wife, 3, 4, and 5, . . . for grandparents, children, and so on, to be added to the family ID code, to produce a personal ID code.

A method for producing an ID code from a telephone number will be explained, with reference to FIG. 3b, wherein a case an ID code is produced for each telephone number taken from personal information will be explained.

A general home wired telephone number is given a particular prefix for a local telephone office. A telephone number is detected from the received information (S74). The wired telephone number consists of 12 digits at the maximum, wherein maximum four digits in forward represent an area, maximum four digits in the middle represent the local telephone office, and last four digits represent a series of numerals of its own. The front four digits represent an area from 145 areas in Korea. Therefore, the 145 area codes are coded by using a two digit code system or a two digit character system (for an example, the English alphabet ‘aa˜zz’: 262), and the coded area code is combined with rest eight digits of numerals (S75), to produce an ID code for each telephone number (for an example, a telephone number 02-3334444 may be given an ID code of “aa3334444”). Though it has not been put into actual use yet, the 145 area codes (four digits) will be replaced with three digit area codes. That is, the 145 area codes will be replaced with 02 for Seoul municipality city, 032 for Inchon integrated municipality city, 051 for Busan integrated municipality city, 053 for Daegu integrated municipality city, 062 for Gwangju integrated municipality city, 042 for Daejon integrated municipality city, 052 for Ulsan integrated municipality city, 031 for Gyunggi province, 033 for Gangwon province, 041 for Chungchung-namdo province, 043 for Chungchung-bukdo province, 063 for Chulla-bukdo province, 061 for Chullanamdo province, 054 for Gyungsang-bukdo province, 055 for Gyungsang-namdo province, and 064 for Chejudo province, respectively. If the area codes are thus converted into 16 area codes, the area codes may be coded by using two characters in English alphabet ‘a’˜‘z’, and the coded area codes may be combined with the seven to eight digits of numerals excluding the area code (S75), to produce an ID code for a telephone number (for an example, 02-333-4444 may have an ID code of “a3334444”) (S76). Or, as another example, a code system or character system with more elements may be used for coding up to eight digits of area code and local telephone office code, and the code may be combined with rest of four digits of numerals of its own, to produce an ID code for each telephone number. Of course, in above two cases, an Internet address may be produced for each address based on the produced ID code for each telephone number, too (for an example, aa3334444@gucci.com). However, when it is intended to include mobile telephone numbers in the ID coding system, code numbers of respective mobile telephone companies (for an example, 011, 016, 017, 018 , and 019) are taken into account in the ID coding; the ID coding is made by giving a code ‘a’ to a wired telephone number, ‘b’ to ‘011’, ‘c’ to ‘016’, ‘d’ to ‘017’, ‘e’ to ‘018’, and ‘f’ to ‘019’, adding an area code and a local telephone office code in a case of the wired telephone number, or a mobile telephone company code and four digits of numerals in the middle in a case of a mobile telephone number thereto, and further adding the last four digits of numerals thereto (for an example, an ID code for a mobile telephone number 019-222-3333 will be “fbbb3333”). Thus, the ID code for telephone number is produced by adding the mobile telephone company code, and an Internet address is produced based on the ID code (for an example: an Internet address for a mobile telephone number 019-2222-3333 will be fbbbb3333@gucci.com). A likely, in this time too, in a case of a family, codes may be given for family members, such as 1 for father, 2 for wife, 3, 4, and 5, . . . for grandparents, children and so on, and added to the family ID code, to produce personal ID codes.

The method for producing a family ID from an enterprise registration number in accordance with a third preferred embodiment of the present invention.

An enterprise registration number is detected from the received information (S77). In this instance, the enterprise registration number includes a tax office code, a code for indicating natural or juridical person, and a tax exempted enterprise, and a serial number, such that no same enterprise registration numbers are produced. Accordingly, by revising the foregoing method for producing an ID code in application to the method for producing an ID code from the enterprise registration number (S78), the ID code for each enterprise registration number can be produced. If the enterprise registration number is 123-45-67890, ‘1’ denotes an area code, ‘23’ denotes a tax office code, ‘45’ denotes a type of the enterprise, ‘6789’ denotes a serial number, and ‘0’ denotes an error inspection number. As one example of the method for producing an ID code from the enterprise registration number, the forward three digits and the middle two digits are combined in coding, and combined with the last serial number, to produce an ID code from the enterprise registration number. That is, the forward three digits (‘123’) are coded into one character ‘a’ of the English alphabet ‘a-z’, two digits ‘45’ in the middle is coded into one character ‘b’ of the English alphabet, and the two codes ‘a’ and ‘b’ are combined with rest of numerals of the serial number, to produce an ID code “ab67890”. A likely, in this instance too, if the enterprise has many members, ID codes for the members may be produced, additionally. That is, a code may be given to each of the members and added to a family ID code, to use as a member ID code.

A method for producing an ID code in accordance with a fourth preferred embodiment of the present invention will be explained.

Referring to FIGS. 3D and 3E, the method for producing an ID code in accordance with a fourth preferred embodiment of the present invention suggests composite combination of the postal code, the telephone number, and the social security number or the driver license number for making decryption of user's information from the ID code difficult, as the ID codes of the first to third embodiment methods, produced by combining the postal code and the address, or from the telephone number or the enterprise registration number, allow general people to understand the user information (an address and a telephone number) with easy, that may be utilized improperly. That is, if it is intended to produce a nine digit ID code, the six digit postal code, representing approx. 900 villages/towns/townships, is hexa coded to produce a two byte data, and is placed at first two digits in the nine digits. This is possible as a combination of characters ‘a-z’ and numerals ‘0-9’ has 362 case numbers. Then, a numeral portion of a house or apartment address excluding an address portion up to villages/town/township is hexa coded, to produce a three byte data, and placed at the next three digits in the nine digits of ID code. Then, the social security number or the state driver license number with many digits is hexa coded into two byte data, and placed at the next two digits. Though the social security numbers or the state driver license numbers each with 13 digits differ for all people in Korea, as described before, since the social security number or state driver license number is hexa coded under a state the postal code and the address are coded, adequate number of codes for all residents living at the same numeral portion of the address can be provided only by using the two bytes of data as residents living at the same numeral portion of the address are below 36² at the maximum. Then, one of the last two digits represents a member of the family, and the last one digit is a given number from program for verification of the ID code. Because no users information can be known from the ID code produced thus, the ID code can not be utilized, improperly. It is evident that the ID code may be produced, not limited to the nine digits, but with digits greater or smaller than the nine digits.

Thus, by giving the ID codes to all people in Korea, every people can have own ID code. The family IDs produced thus are built up as a data base for each member and stored in a member DB. Once the ID code is produced and stored in a member DB, the accesser is determined of being a member, and, if the accesser is determined to be the member (S50), the storage part 140 having data received from business connections and stored therein is searched for a data to be provided to the member (S90). When the data to be provided is found, the data is transmitted by E-mail to the ID of the member through a family ID stored in the member DB 130 (S110). The coming into force of the electronic signatory law (Law No. 5729) on February 1999, the availability of safe transmission of official documents on the Internet owing to development of security systems, and the matured information and communication environment facilitate the putting into actual use of the present invention. That is, an electronic signatory authentication organization is built up lead by Korean government for establishing a system for electronic reception/transmission of official documents between governmental offices and administrative organizations, and processing civil applications on Internet. Recently, Korean government has organized “Managing conference for the electronic signatory authentication organization”, and determined to set out for building up the electronic signatory authentication organization lead by the Korean government by means of fully authorized task force. It is determined that six governmental bodies of National Intelligence Service, Ministry of Government Administration and Home Affairs, Ministry of Planning and Budget, Ministry of Finance and Economy, Ministry or Commerce, Industry and Energy, and Ministry of Information and Communication take part in the conference, with an executive official for government information management planning nominated as a chairman, under which a task driving team, a technical supporting team, a law modifying team, and a fully authorized task team for building up the organization are established. Then, the service provider 100 puts a transmission mark on the data transmitted to the member and stores temporarily in the storage part 140 for a certain period. Then, after the certain period is passed, erasure or re-transmission of the data is determined depending on payment by the member. As a result of the determination, if the member has paid, the data is erased, and if the member did not pay, the data is re-transmitted with a penalty added thereto. The service provider 100 searches the storage part 140 at fixed time intervals, and, if a data to be transmitted to a member is occurred, the data is transmitted to the member by E-mail at the family ID stored in the member DB 130.

Thus, on one side, the service provider produces the proper ID code based on the user information and sends out the notice to the produced proper ID code, and, on the other side, the service provider induces the user to input an ID code of the users preference, so that the ID of the users preference provided by the user and the family ID produced by the service provider are used together (the ID of the users preference corresponding to the family ID is managed by using a look up table, for sending out the notice either to the family ID or to the ID of the users preference). Moreover, the service provider may charge no fees or service charges to the users, but may transmit E-mail to the member with an advertisement added thereto, to take an advertising charge, instead.

When the family IDs, produced for each address by the method for producing a identification code, come into wide use, to be employed in administrative affairs and applied to Internet, a great innovation in the administration will be brought about, that accelerates realization of an electronic government, to provide a turning point of a great administration reformation. Consequently, there will be reduction of notice paper, printing, and delivery as well as delivery manpower and delivery fees, such as postal charges. Moreover, in selling /buying goods on Internet, use of the family IDs for each address makes the users to dispense with the requirements for applying personal information, and sellers to have a highly reliable user, to promote settling of the home shopping earlier.

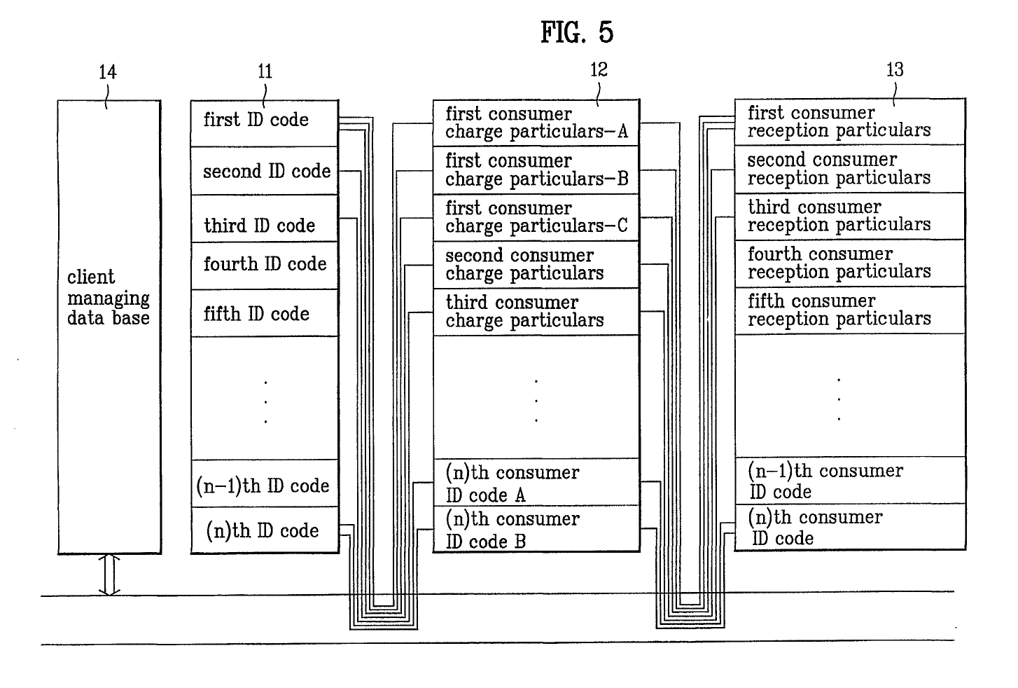

Next, an electronic notice procedure will be explained, which is served by using the ID code of the address, the person, the telephone number, or the enterprise registration number, for which an electronic notice system will be explained, at first. FIG. 4 illustrates a block diagram of a system for giving an electronic notice service in accordance with a preferred embodiment of the present invention, and FIG. 5 illustrates data bases managed by a host server in a system for giving an electronic notice service of the present invention.

Referring to FIG. 4, the system for giving an electronic notice service in accordance with a preferred embodiment of the present invention includes a host server 10, a plurality of data bases 11, 12, 13 and 14 managed by the host server 10, and a user's computer. A client managing data base 14 among the plurality of data bases 11, 12, 13 and 14 has personal information (a postal code, an address, a telephone number, social security number or state driver license number) taken when the user(receiver) registers as a member of a web site for giving the electronic notice service of the present invention, or enterprise information, and information on the electronic notice service of the present invention, stored therein. The first data base 11 has users ID codes produced at the host server 10 based on the personal information (a postal code, an address, a telephone number, social security number or state driver license number) stored in the client managing data base 14 stored therein. In other words, as explained, the users proper ID codes employed in the present invention are produced from public codes that are general, universal, and socially well known, such as postal codes, addresses, telephone numbers, social security numbers or state driver license numbers, and stored in the first data base 11. The ID code of the users preference taken when the user registers as the member is also stored in the first data base 11. The second data base 12 has various charge notice particulars for each receiver received from various notice issuers (tax offices, local autonomous entities, credit card companies, insurance companies, the public corporation for medical insurance, communication companies, the public corporation for city gas, the city water business headquarter, the public corporation for electricity, and the like) stored therein, with the various charge notice particulars sorted according to the ID codes connected to the proper ID codes (or the ID codes of the users preference) for each receiver stored in the first data base 11. Particularly, the second data base 12 may store many charge notice particulars for one ID code in an order of due dates, which order may be changed at the due date. The third data base 13 has receipt particulars of payments which the host server 10 is in reception according to payment method fixed in advance by receivers in connection with banking facilities, with the receipt particulars of payments sorted according to the ID codes connected to the ID codes for each receiver stored in the first data base 11. Especially, the data bases 11, 12, 13, and 14 are arranged as shown in FIG. 5, so that the host server 10 can process information on the electronic notice services in package based on the data stored in the different data bases 11, 12, 13, and 14. The data bases 11, 12, 13, and 14 are protected by a secondary fire wall, which fire wall only allows permitted and authorized information from Internet passed through the host server 10.

Basically, the host server 10 has a router (not shown) for providing a network through Internet, and the user computer 20 and the notice issuer (not shown) also have modems for connection to Internet or are connected to a local network, such as a LAN. The router to the host server 10 fixes a network path at first, provides an initial access to the path, and designates an actual path for the host server 10. The host server 10 interfaces a web page as the notice issuer or the user (receiver) accesses to a web site for the electronic notice service of the present invention, to display a required web page on a computer 20 of the notice issuer or the user, for which, as an example, an HTTP (HyperText Transfer Protocol) is used among the computers 20 of the notice issuer and the user, and the host server 10.

The host server 10 for giving the electronic notice service of the present invention has software for producing user ID codes to be stored in the first data base 11 and assigning the ID codes to the receivers of individuals/addresses/telephone numbers/enterprise registration numbers, software for producing corresponding Internet addresses from the ID codes, and assigning the Internet addresses to the receivers, software for converting the particulars of charge notices for each receiver received from the notice issuer through the Internet and stored in the second data base 12 into electronic documents (for an example, a software for converting into E-mails, which is one form of electronic documents), software for managing both the proper ID codes and the ID codes of the users preference in implementing the electronic notice service of the present invention by even using any one of the two ID codes, and web software for servicing the electronic notice of the present invention. Eventually, when there is a request to send particulars of charge notice from the receiver, the host server 10 produces an Internet address from the proper ID code or the ID code of the users preference stored in the first data base 11, converts the particulars of the charge notice into an electronic document, and transmits to the produced address. When the host server 10 has software for converting the particulars of the charge notice received from the notice issuer into an electronic document (for an example, E-mail writing up software when an E-mail is used), an STMP (Simple Mail Transfer Protocol) is used as an example for transmission of the E-mail between the user computer 20 and the host server 10. Also, the host server 10 analyzes particulars of payment reception stored in the third data base 13 and provides an extra electronic document (for an example, an E-mail or a simple text) for suggesting a direction of economic activity to the receiver based on the analyzed particulars of the received payment. That is, a relation of the monthly paid amount with a reference preset according to an income for the receiver taken at the time of member registration is examined, and, if it is determined that the paid amount occupies a too large share in the reference fixed based on the income, provides words to the receiver for recommending an adjustment of a home economy. Moreover, the host server 10 may provide the receiver with an E-mail which only contains advertisement, notices, or general documents. Besides, the host server 10 carries out a general function of authenticating the receiver by acknowledging the receiver, and a function informing a fact to the issuer that the notice is given to the receiver when the particulars of the charge notice is delivered to the receiver. Alike the various data bases 11, 12, 13, and 14, since the host server 10 needs a security too, a primary fire wall having a function identical the secondary fire wall is provided to the host server 10.

The user computer 20 receives the E-mail from the host server 10, restores the charge notice particulars, and display the particulars to the receiver. Of course, the host server 10 transmits the E-mail with the E-mail encrypted with open key/encryption key known to each other at an authentication negotiation made between the host server 10 and the user computer 20, and the user computer 20 also decrypts the E-mail with the open key/encryption key known to each other at the authentication negotiation made between the host server 10 and the user computer 20. The formats of the transmitted documents are not limited to the E-mail, but may be a simple text or other documents. For reading particulars of the charge notice restored on the users computer 20, mail receiving software in the users computer 20 is driven, and a list related to charge notice/remittance in a displayed mail list is selected. Then, the particulars of the charge notice are read, or a result of payment is confirmed. Though not shown in the drawings, the computer of the notice issuer has functions similar to the users computer 20.

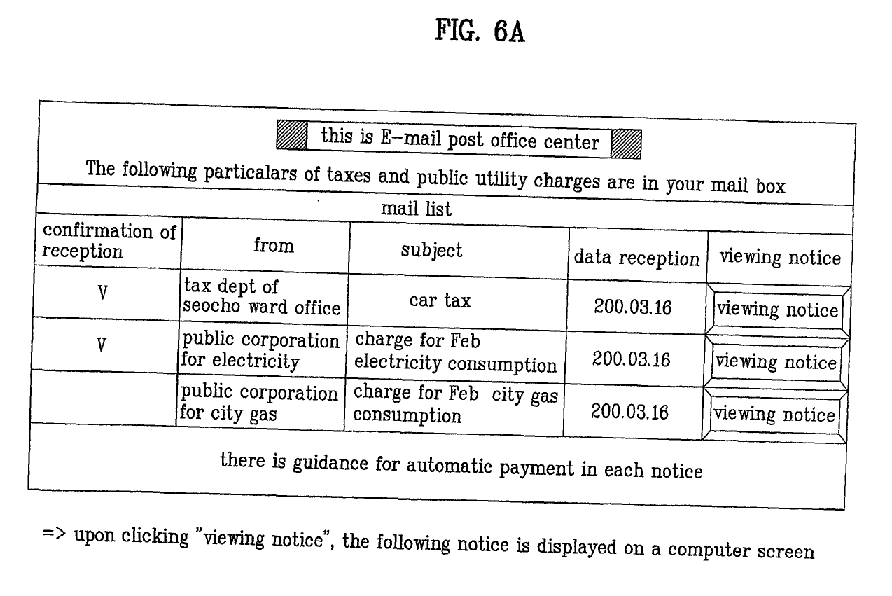

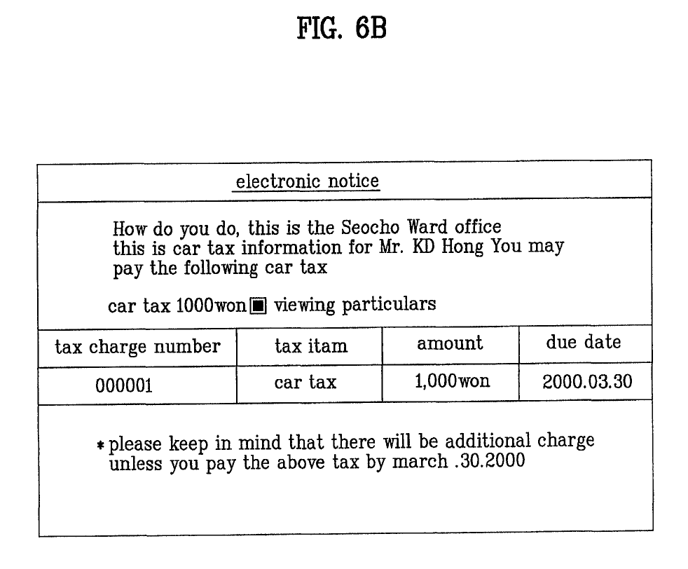

When the electronic notice is made by the electronic mail in the present invention, FIG. 6 illustrates examples of a mail list format displayed on the users computer as the mail reception software in the users computer is driven, and an electronic notice format displayed on the user computer as the user selects one list related to charge notice/charge settlement on a mail list.

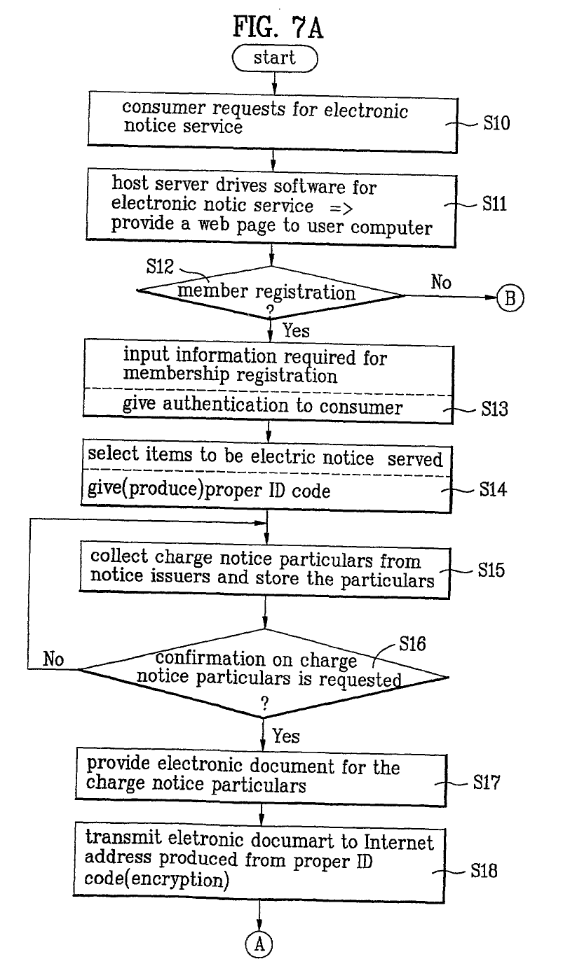

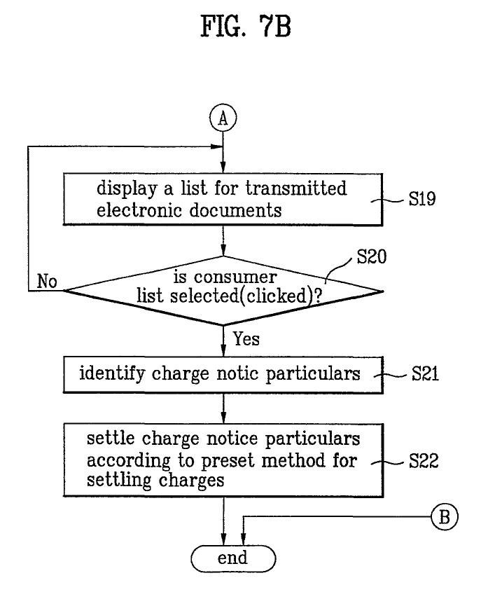

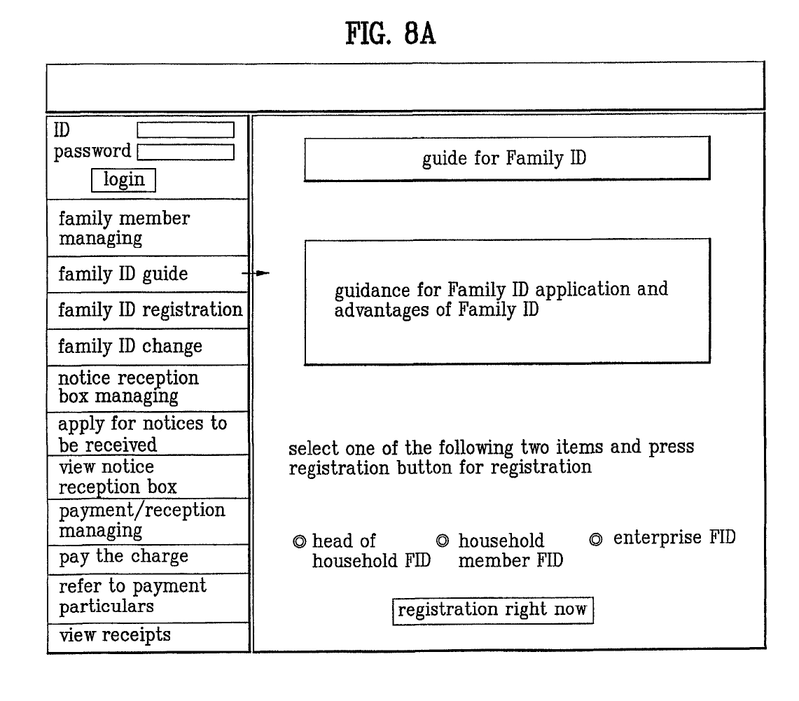

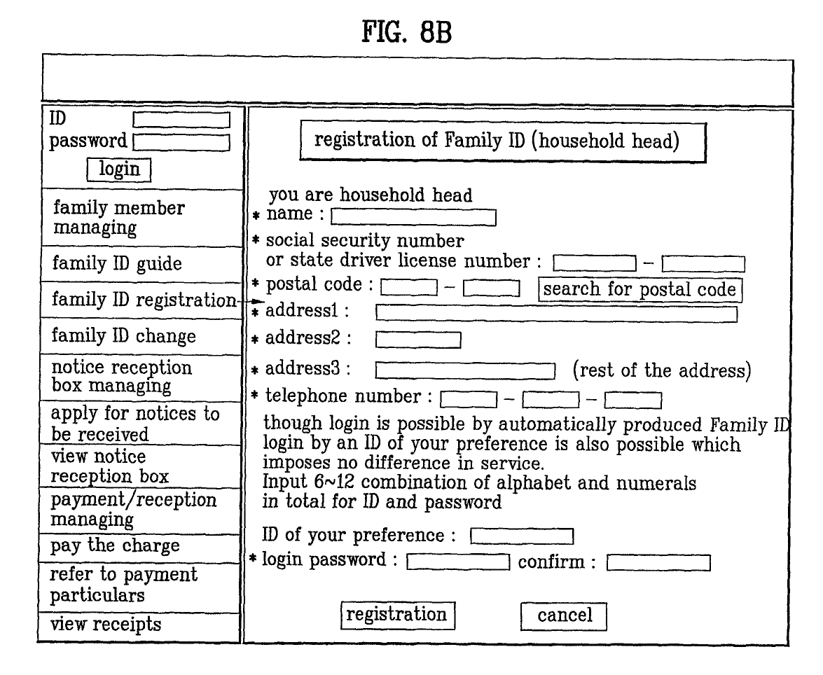

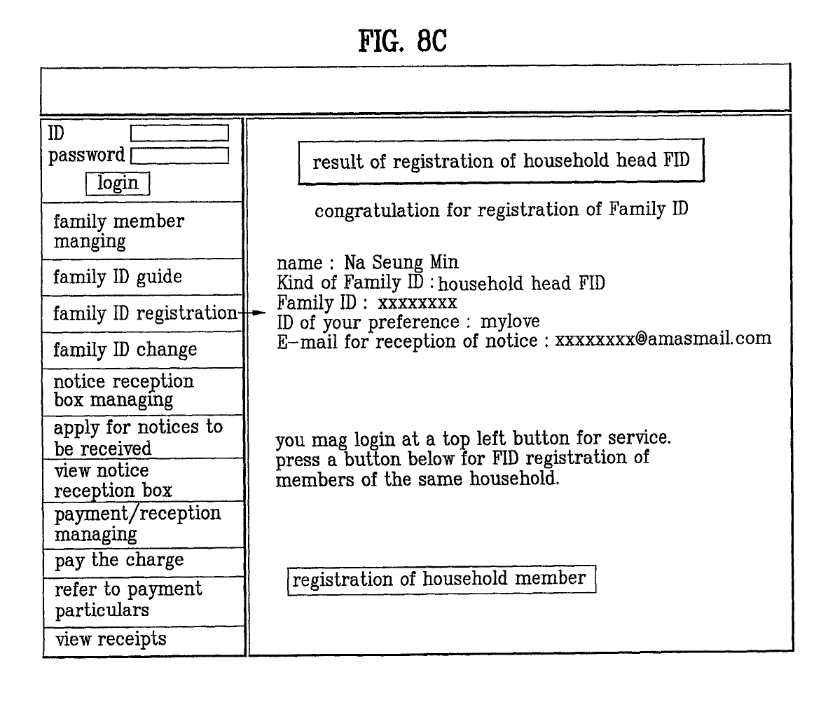

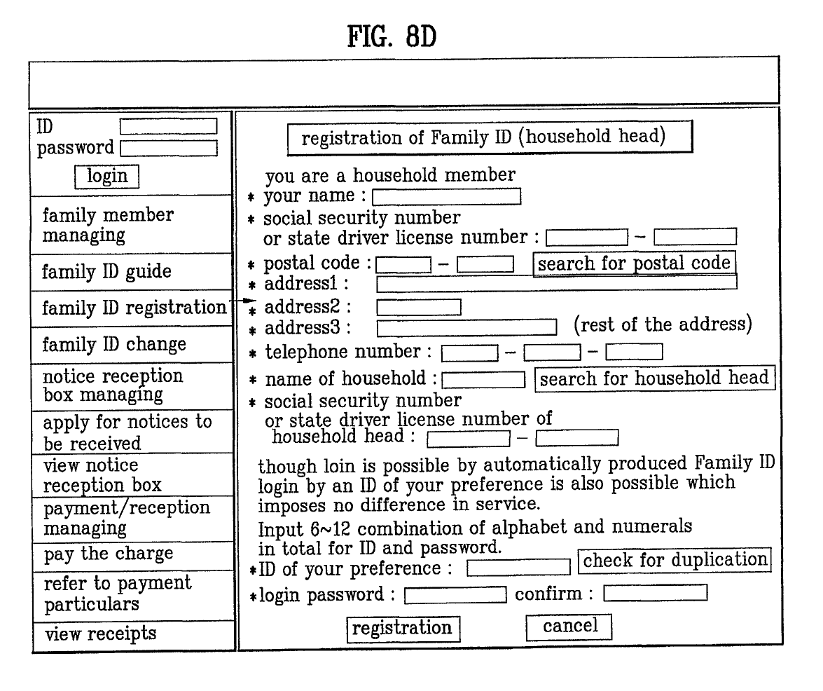

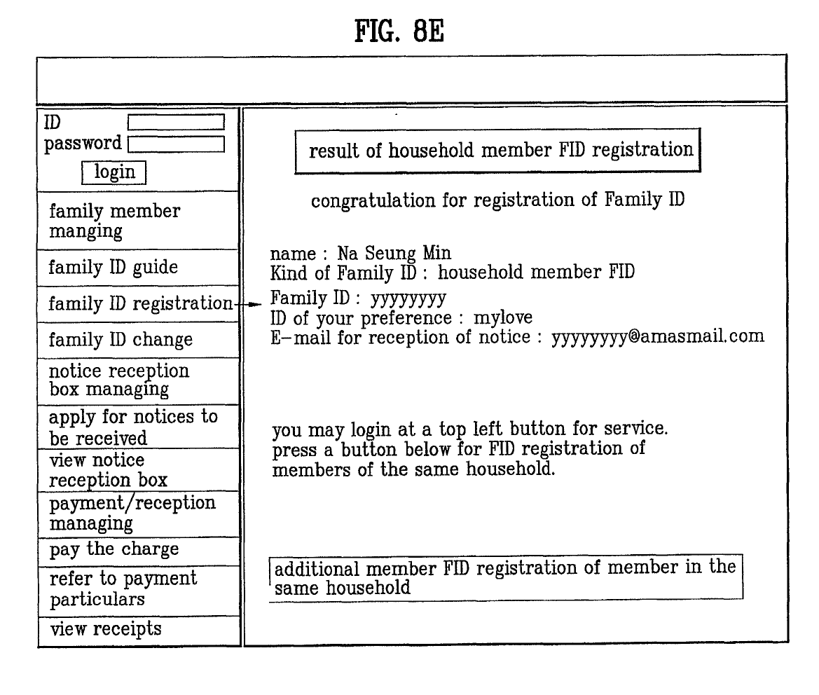

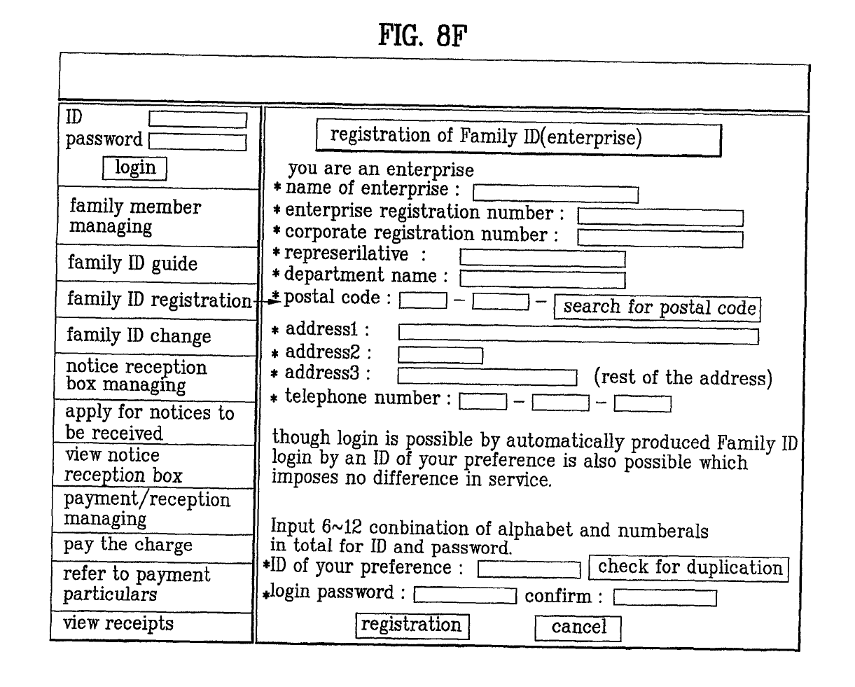

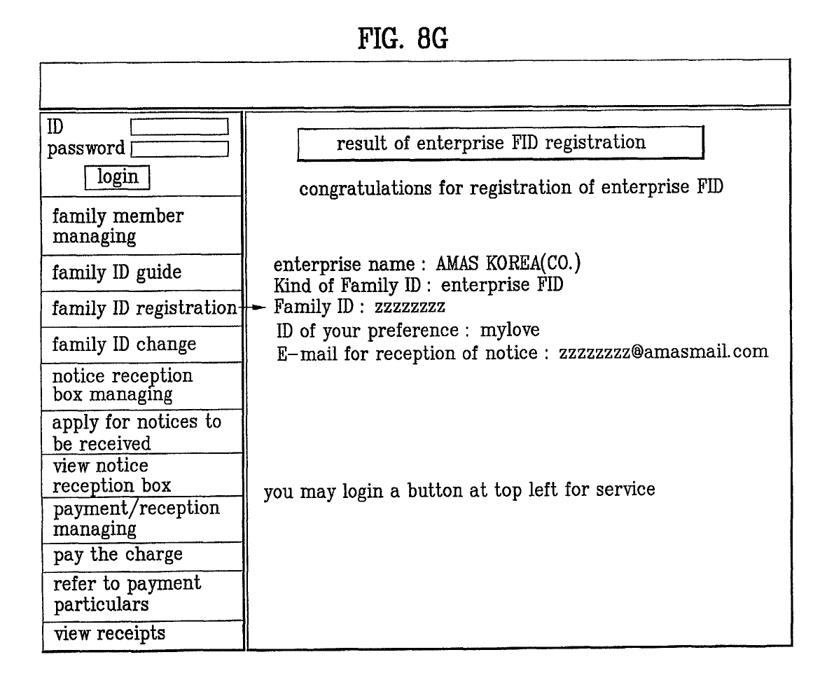

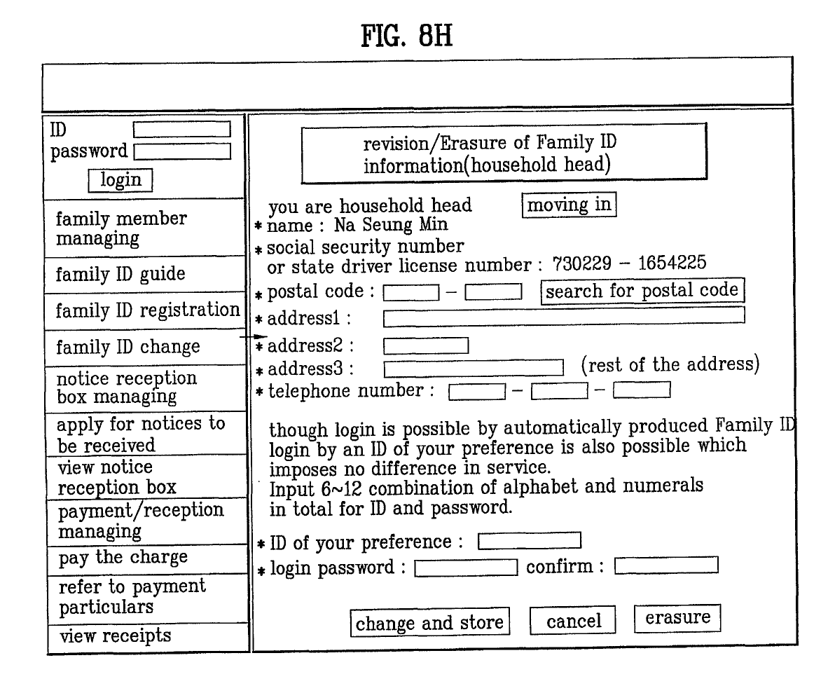

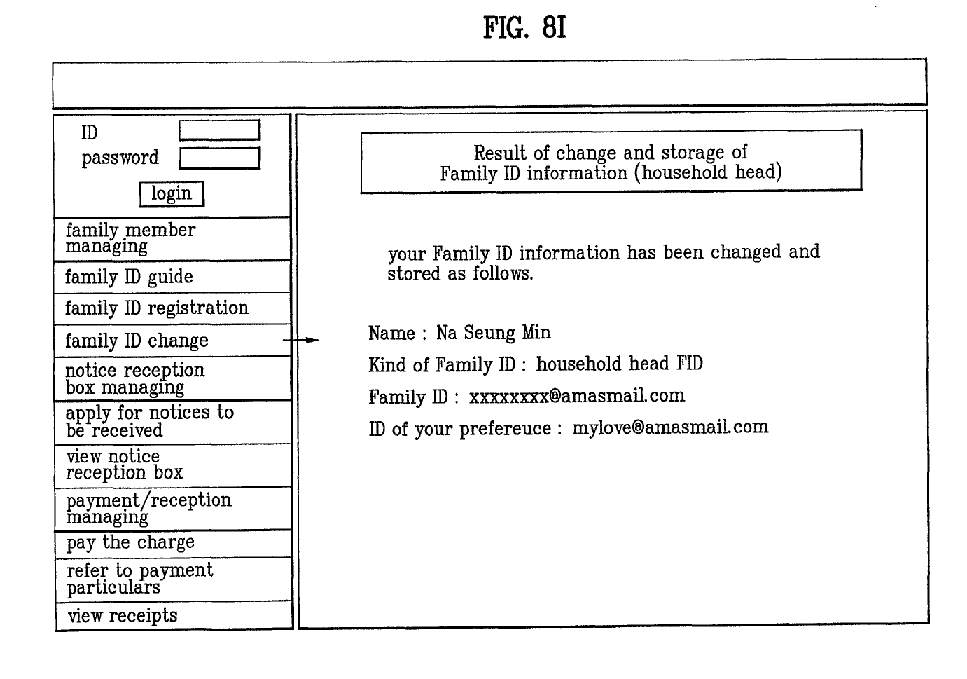

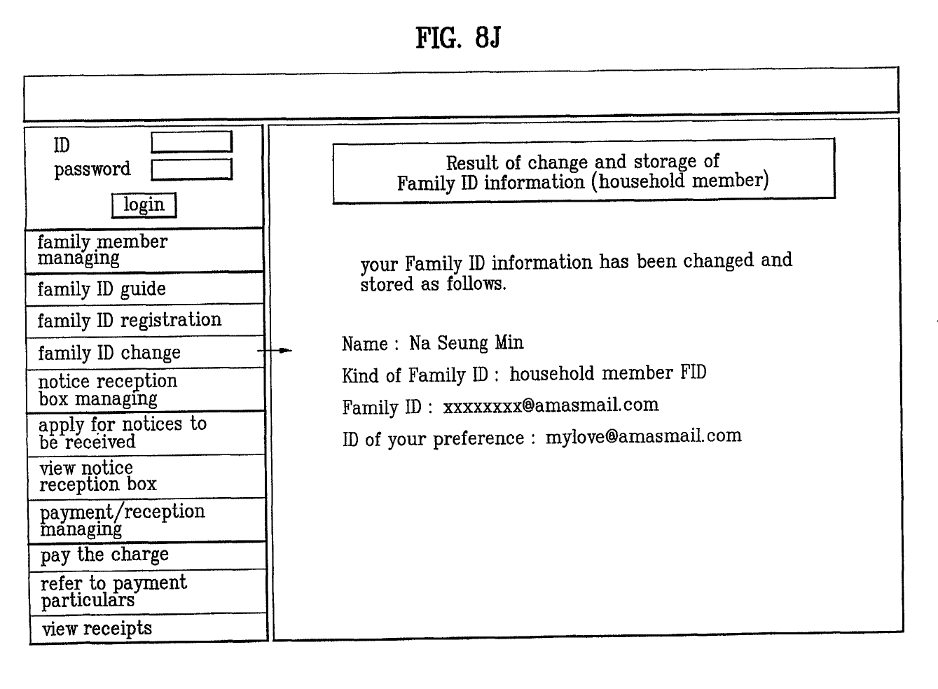

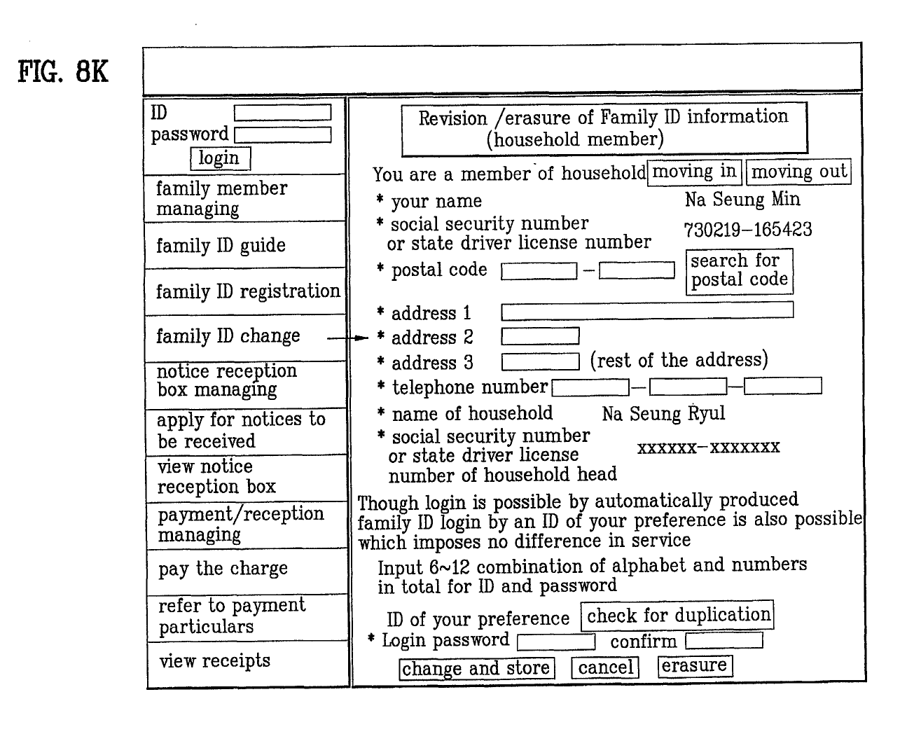

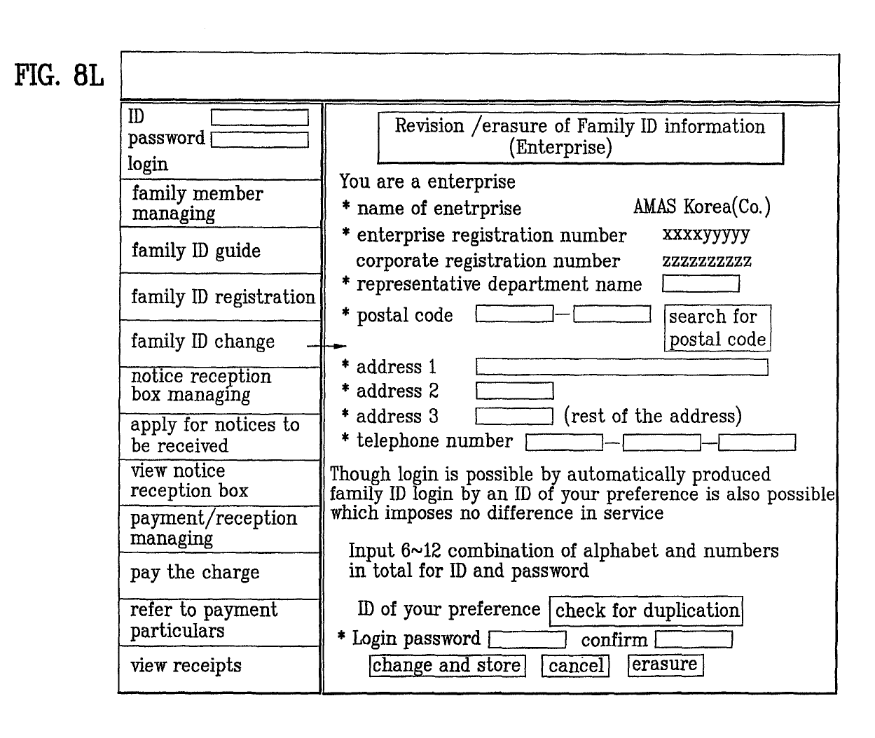

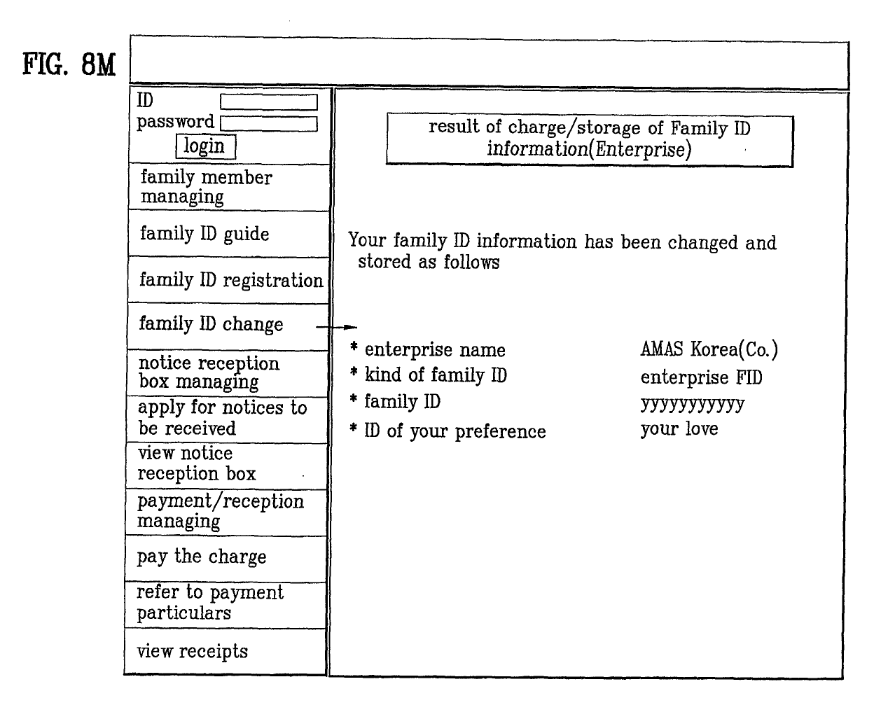

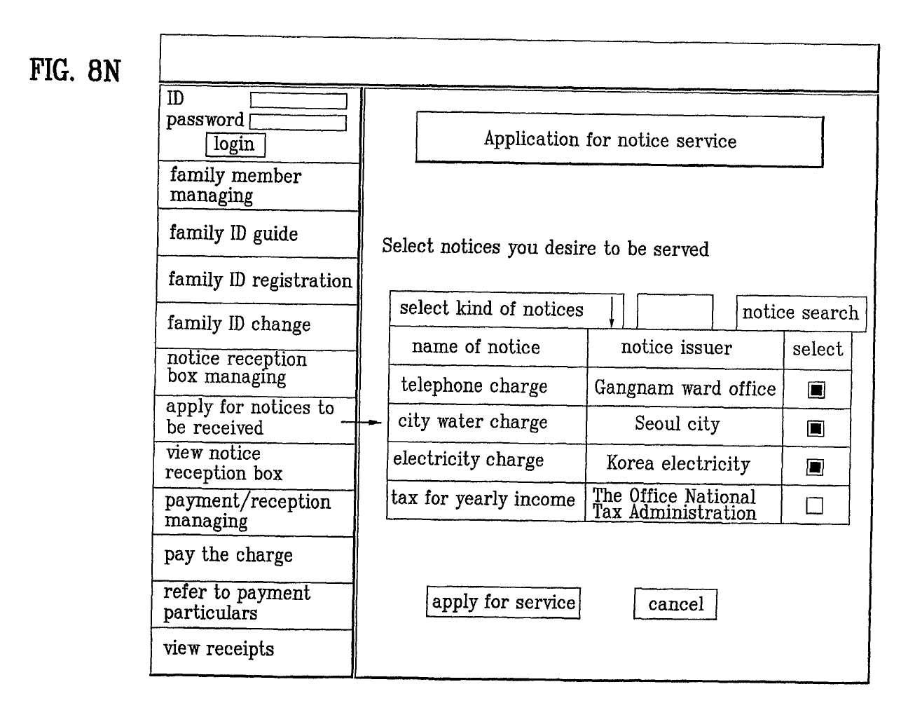

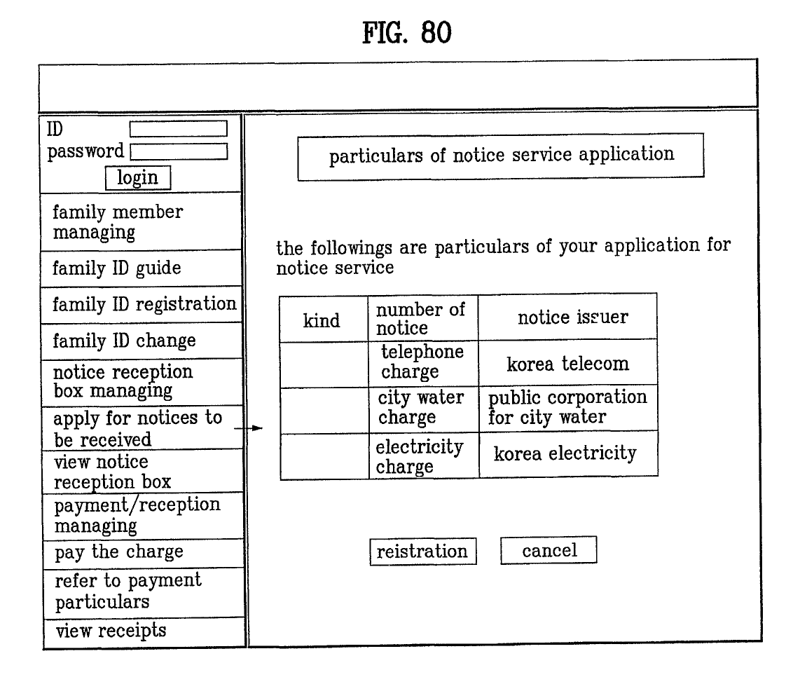

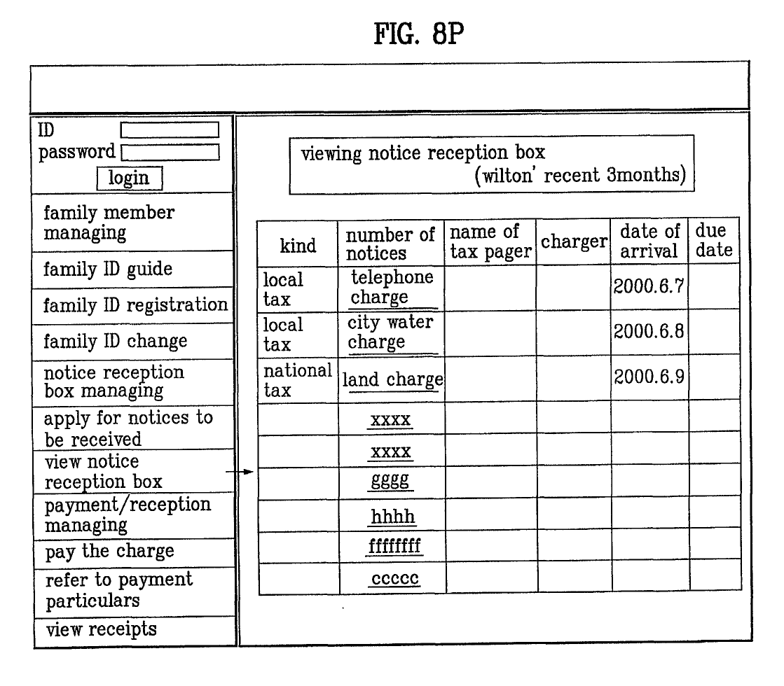

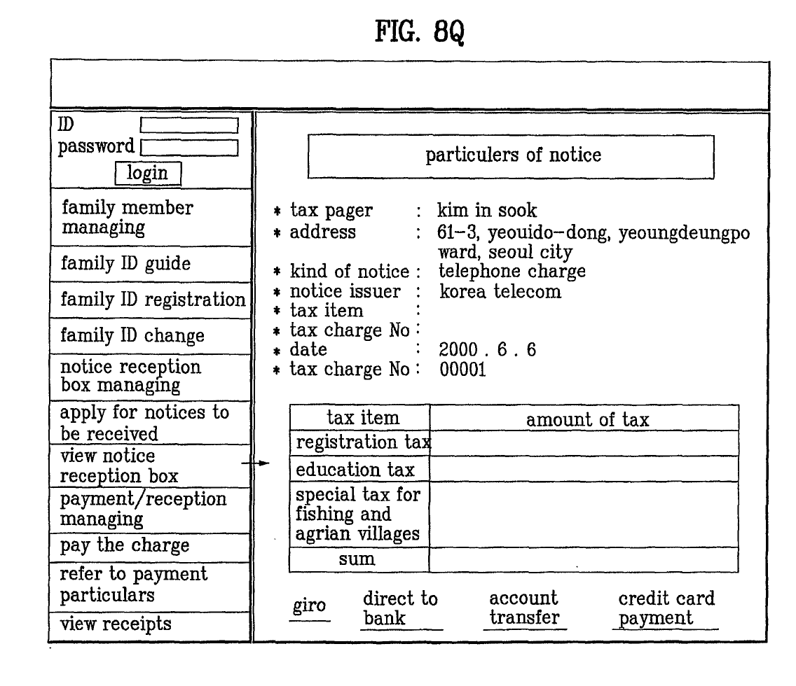

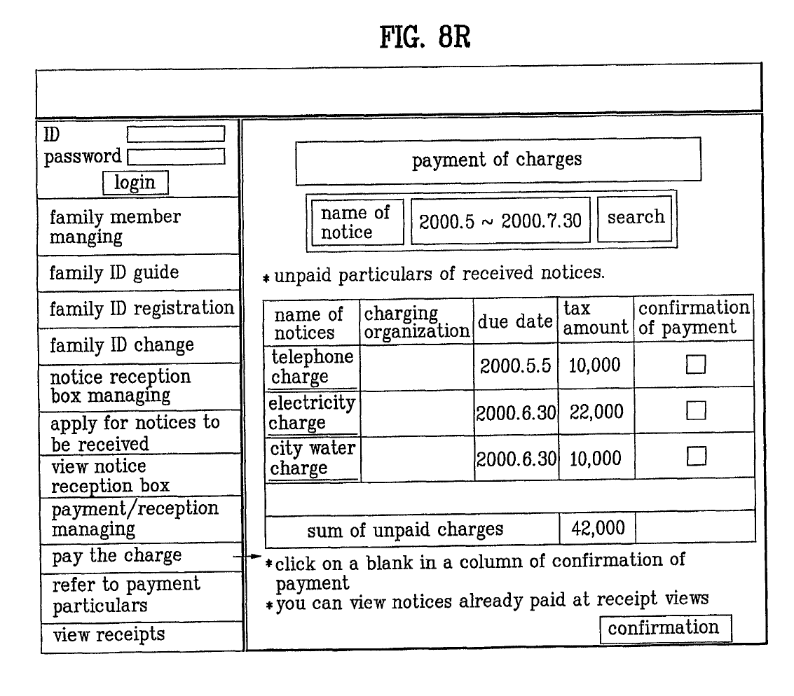

The electronic notice service of the present invention is implemented by the foregoing system and operation of the system elements, and the operation of the system elements are implemented further through the electronic service procedure explained below. FIG. 7 illustrates a flow chart showing the steps of a service process for giving an electronic notice in accordance with a preferred embodiment of the present invention, and FIGS. 8A˜8R illustrate basic screens required for providing a membership management, administration of a notice receiver box, payment administration, and alarm function.

Referring to FIG. 7, when a receiver requests for an electronic notice service through a user (receiver) computer 20 (S10), the host server 10 drives the electronic notice service software, to provide a required web page on the users computer 20 through web interface (S11). That is, as shown in FIG. 8A, when the user clicks on “family ID registration” on a web page which explains advantages obtainable upon using the electronic notice service and a guidance for becoming a member, a draft agreement is displayed. When the user agreed to the agreement, a member registration screen is displayed. The member registration is made in three categories of an ID of a head of a household, an ID of a member of a household, and an ID of an enterprise. Therefore, upon pressing registration button, it is required to select a family ID before the registration screen is actually displayed. Then, the user (receiver) is required to input personal information (a name, age, a social security number or a state driver license, an address inclusive of a postal code, a telephone number, and the like) for registration, or, when the receiver is an enterprise, enterprise information (an enterprise name, an enterprise registration number, an address inclusive of a postal code, a telephone number, and the like), as well as information related to the electronic notice service of the present invention (types of the electronic notice, such as monthly or yearly income of the receiver, financial information, such as a correspondent bank, a type of payment, date of payment, and the like, a form of notice reception, by an E-mail or a simple text, and the like) (S13).

Referring to FIG. 8A, when the head of a household registers the ID, the web page is displayed, so that the head inputs a name, a telephone number, a social security number or a state driver license number, a postal code, an address, an ID of preference, a login pass word, and the like. The address is inputted divided into two portions; a portion (address 1) down to city (province), ward (township), and village (town/township), and the other portion (address 2) of numeral portion, and the address is inputted divided into three portions when the address is of an apartment; a portion (address 1) down to city (province), ward (township), and village (town/township), another portion (address 2) of numeral portion, and a third portion (address 3) for an apartment name, building number, and an apartment number. For the convenience of the user, the postal codes are made to be found with easy, and upon inputting all the items, the registration is clicked. Upon registration of the head of a household, a result of the registration is displayed as shown in FIG. 8C. Alikely, as shown in FIGS. 8D and 8E, when a member of the household registers, the web page is displayed as explained before, and, when inputting of required information is completed, a result of the registration is displayed. Moreover, alikely, as shown in FIGS. 8F and 8G, also when the enterprise registers, the web page is displayed as explained before, and when inputting of required information is completed, a result of the registration is displayed.

The information on the various users (receivers) can be revised whenever the user (the receiver) requests a revision through a web page of a web site for the electronic notice service. That is, as shown in FIGS. 8H to 8M, information on the user ID code is made to be revised/erased. Particularly, an easy revision of the address is made available for a case of house moving of the user, except the social security number or the state driver license number for maintaining and managing the present data even in the case of house moving, using which as base information the particulars of charge notice and payment for users or households are conserved for three years, and a result of the revision is displayed. As shown in FIG. 8H, if the household head clicks on the erasure, the erasure is made possible only when there are no household members in the household. As shown in FIG. 8J, when a member of the household intends to be an independent household member, a button for “forming an independent household” is used, to produce a new household ID, and, on the other hand, the member in the present household is erased. As shown in FIG. 8J, selection of a “moving in” button means joining to other household, and selection of a “moving out” button means joining to other household or forming an independent household.

The host server 10 applies the personal information to an authentication organization for an authentication, thereby authorizing the receiver (S13). When the authentication is successful to prove the receiver's identity, the host server 10 displays the next web page so that the receiver selects items (taxes, such as private auto taxes, license taxes, property taxes, general land taxes, and residential taxes, various public utility charges, such as gas charges, city water charges, electricity charges, telephone charges, and other service charges, such as medical insurance bills, pensions, auto installments, mobile telephone charges, and the like) to be served by the electronic notice service, and applies the personal information received from the receiver to one of the methods for producing and giving an ID code explained before, thereby giving the ID code to the receiver (S14). Accordingly, the receiver selects desired notice issuers, which are stored in the client managing data base 14. Especially, items of particulars of charge notice for each receiver in the second data base 12 connected to the ID code of the receiver stored in the first data base 11 varies with a number of notice issuers for each receiver stored in the client managing data base 1 1.

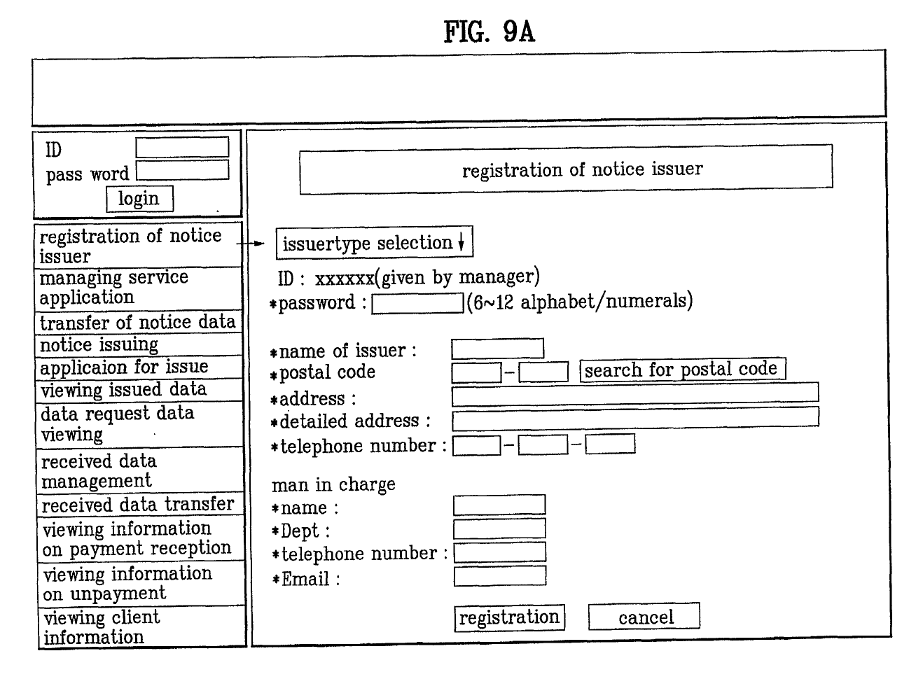

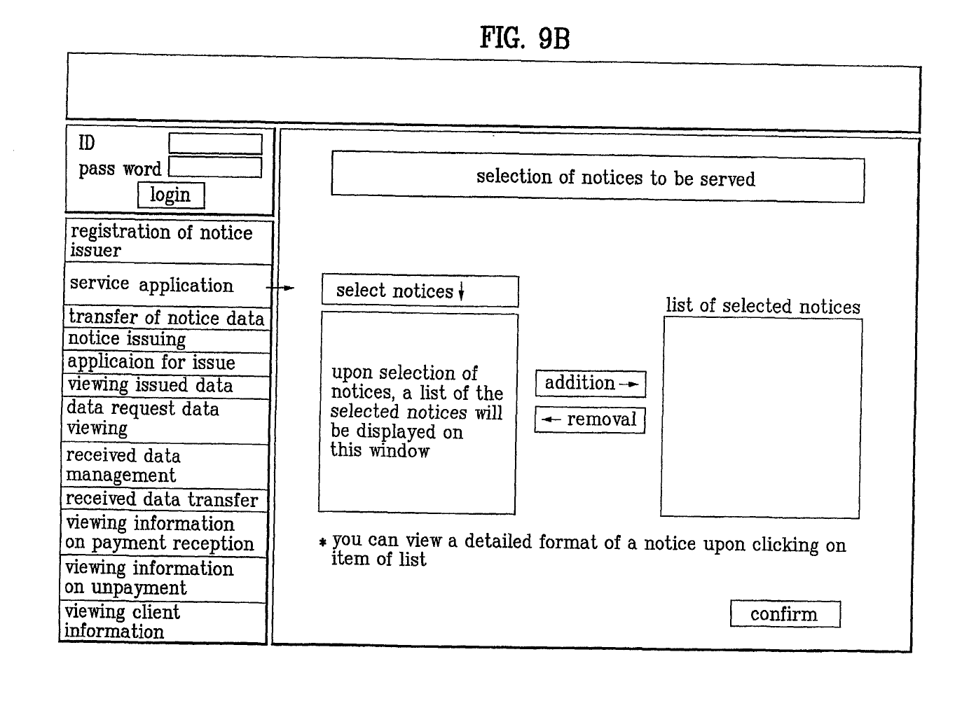

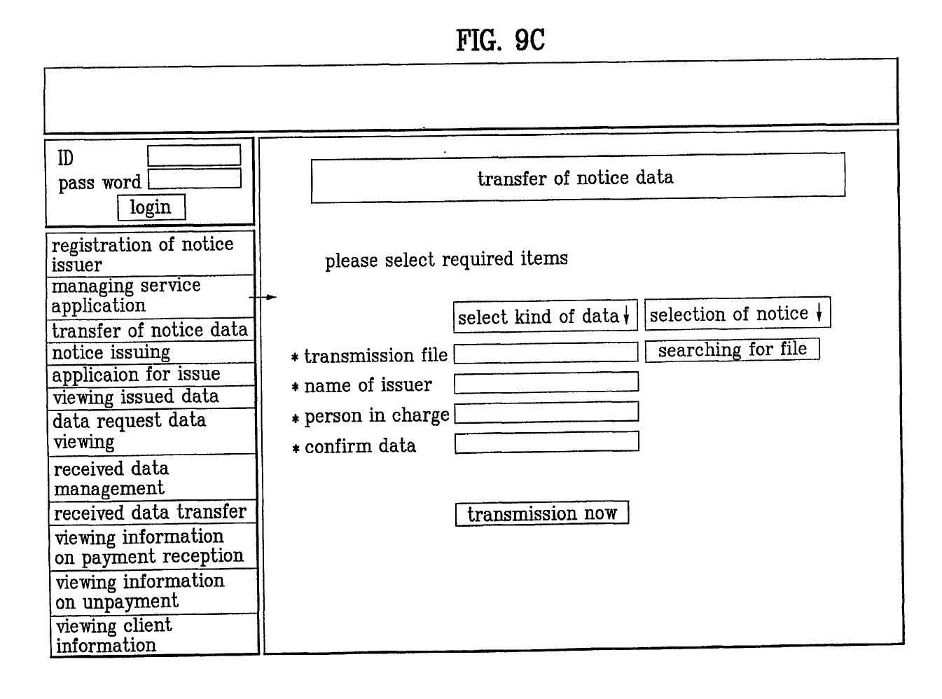

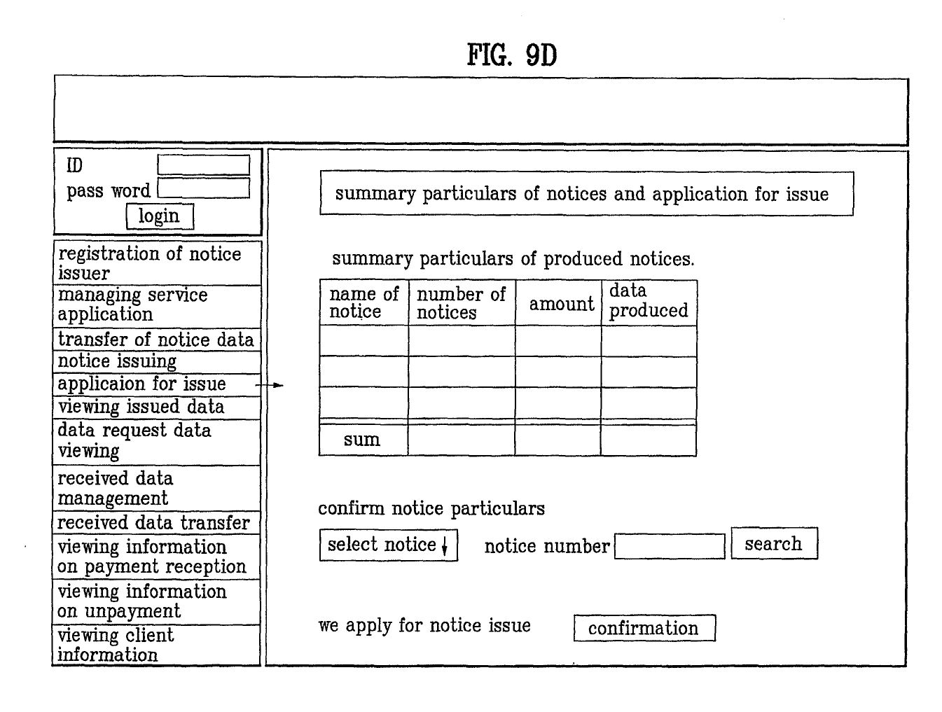

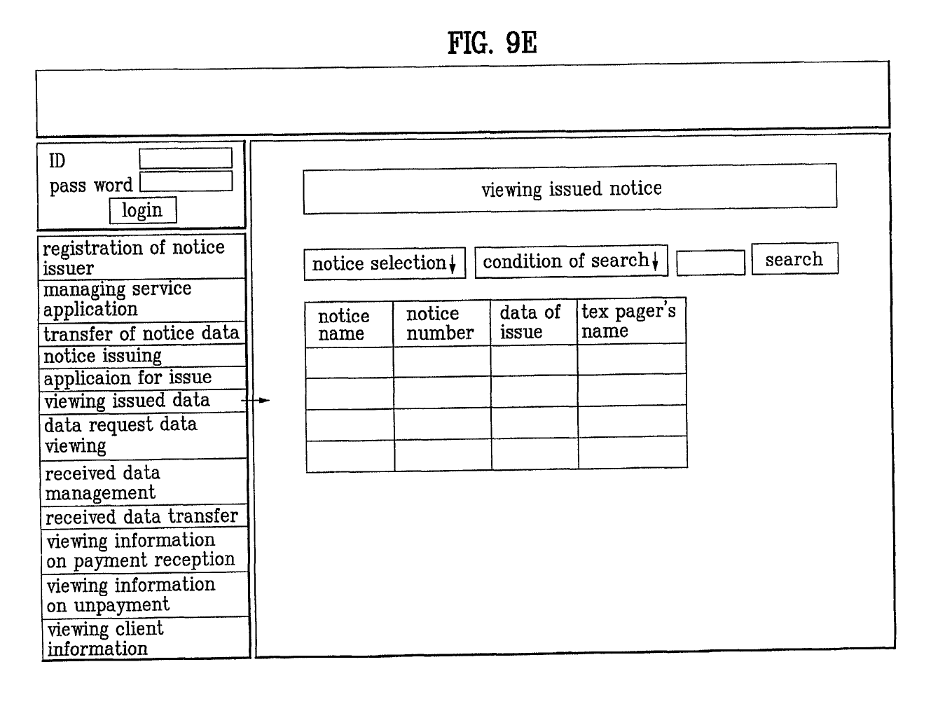

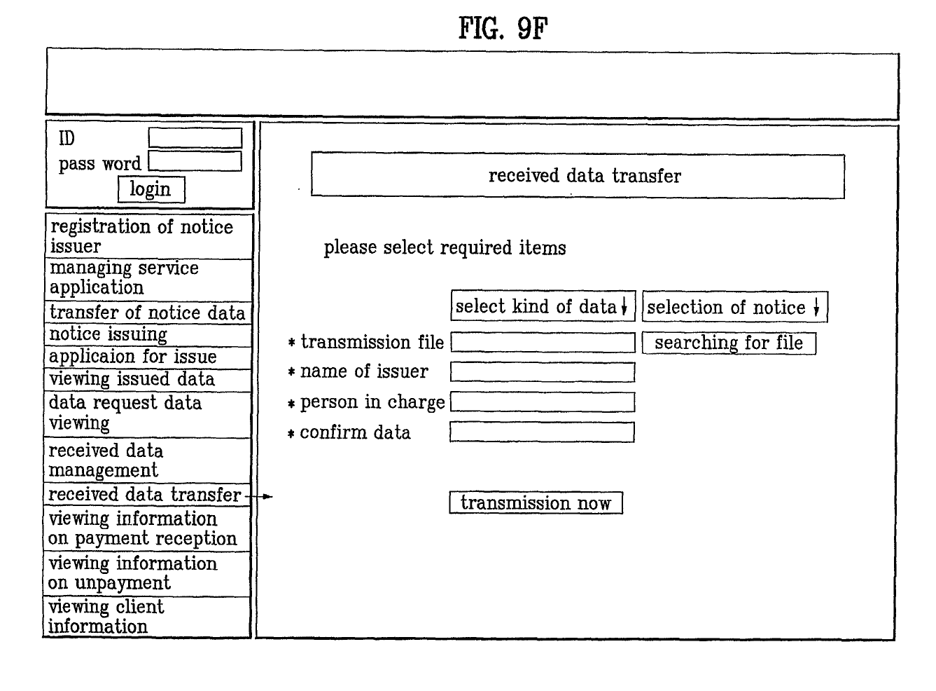

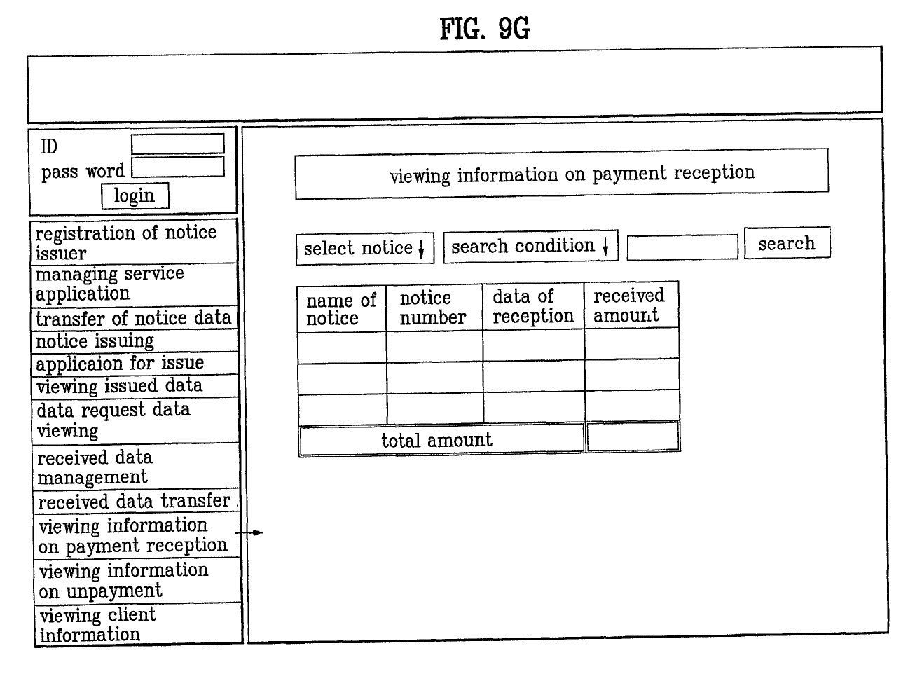

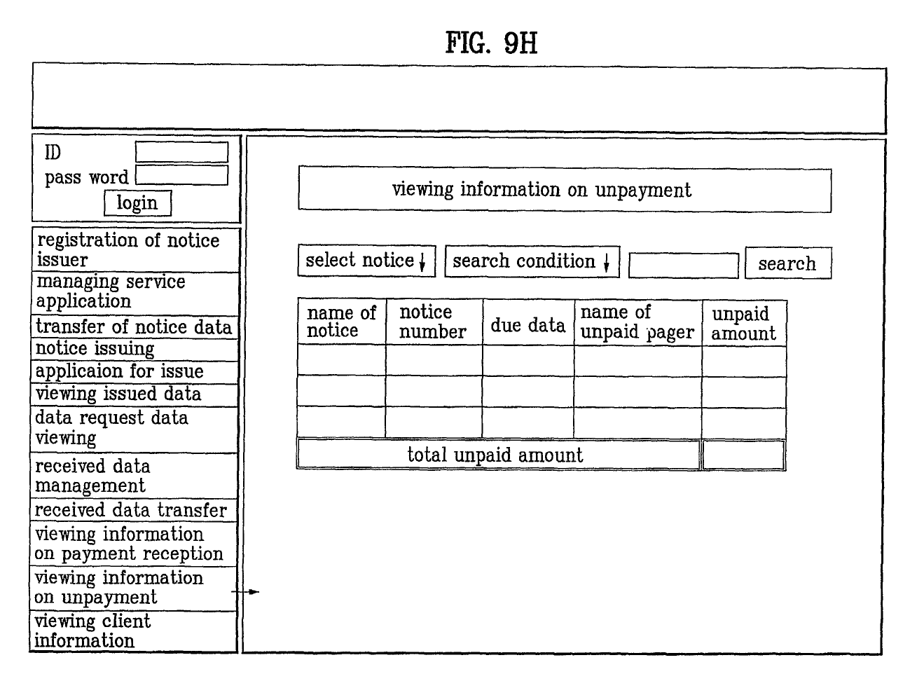

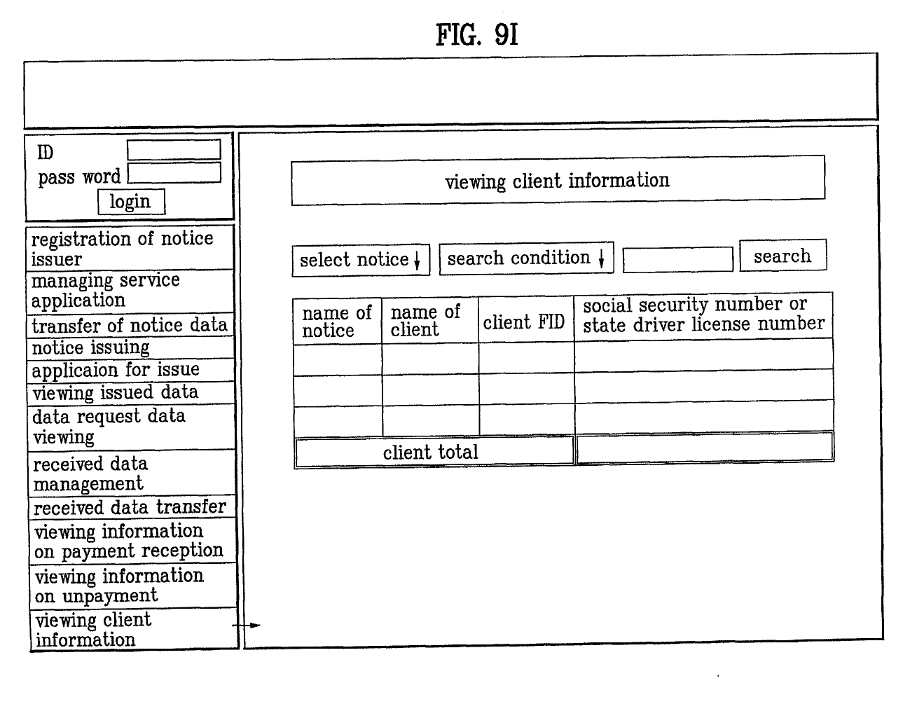

That is, FIG. 8N illustrates a screen for applying notice service by the user, wherein, when the user selects kind of notices from a drop down list, a list of notices is displayed. When blanks for selection are clicked, the clicked notices are selected, or alternatively, a desired notice may be inputted for search, and the desired notice may be selected from a result of the search. Moreover, the notice name is hyper linked, to provide a new window for the notice that gives a detailed explanation of the notice, if the notice name is clicked. Upon clicking “application for service” after the notices are selected, a result of the application is displayed as shown in FIG. 80. Then, the host server 10 collects particulars of charge notices for many users (receivers) registered as members from various notice issuers, and stores in the second data base 12, with the notices made to be connected to the proper ID codes of the users (receivers) produced and stored in the first data base 11 (S15). Then, the host server 10 makes an exact calculation of one or more particulars of charge notices collected, and stores in the second data base 12, with the notices separated for each receiver and due date, the operations for which will be explained with reference to FIG. 9 in detail, later.

Thereafter, when a member user (receiver) makes access to a web site for an electronic notice service, and requests for making sure of the particulars of charge notices form the notice issuer the user selected {of course, even if there is no request for a member registration or electronic notice service by the user (receiver), the host server 10 automatically provides electronic documents for the particulars of charge notices to be paid to the user (receiver) at intervals dutifully}, the host server 10 provides an Internet address from the ID code of the requested user (receiver) stored in the first data base 11, reads particulars of the charge notice of the ID code of the user (receiver) from the second data base 12, and provides the electronic documents (S16, and S17). In this instance, the proper ID code for each receiver, or the ID code of the users preference may be used as the Internet address based on the personal information the user has inputted. The electronic documents may be an B-mail, or a simple text, which are a matter of embodiment. The E-mail written up by the host server 10 is transmitted to the Internet address upon request by the user (receiver) (S18). The electronic document is encrypted with the encryption key produced in the authentication negotiation.

A procedure for making sure of the particulars of charge notice on a users computer 20 by the user (receiver) will be explained. A case will be explained, when the host server 10 writes up the electronic mail by using electronic mail writing up software built therein. The user computer 20 decrypts the electronic E-mail by using a decryption key produced in the authentication negotiation. Then, when the receiver drives mail reception software built in the user computer 20, various mail lists are displayed (S19). As shown in FIGS. 6, 8P, and 8Q, a list related to charge notice/charge settlement is selected (clicked) on the displayed various mail lists, to display the electronic notice of the selected list, on which the receiver can make sure of the particulars of charge notice (S20, S21). If the login is made in the ID of the household head, charge notices even for the household members can view, and if the login is made in the ID of the household member, charge notices only for the member can view. A list of notices within recent three months is displayed in default, and, because the names of the notices are hyper-linked, upon clicking on which a separate window is provided, to display a detailed particulars of the charge notice, and payment of the charge is linked to the end of the screen of the detailed particulars. For making sure of the charge notice and paying the charged amount, the user (receiver) requests a banking facility to fix a type of charge settlement in advance (S22). The types of charge settlement the user (receiver) takes may be account transfer, Internet banking, giro system, and credit card payment. The receiver selects one from these to fix the type of charge settlement with the banking facility, information on which is stored in the client managing data base 14 by the host server 10 in membership registration. If the type of charge settlement is account transfer, a required amount of money is transferred from a bank account in the banking facility to a bank account of the notice issuer as a payment, when no electronic receipt is required. If the type of charge settlement is Internet banking, the settlement is made by means of scheduled payment or spot payment under a condition the receiver fixes the type of payment with the bank in advance, when the bank informs particulars of reception to the host server 10 to store in the third data base 13. If the type of charge settlement is a giro system, a required amount of money is paid by means of giro issued from Korea Financial Telecommunications and Clearing Institute, and, if the type of charge settlement is the credit card payment, a required amount of money is paid as the receiver pays the amount to a credit card company of the receiver. Of the various types of charge settlement, in a case the particulars of reception for the charge notice is stored in the third data base 13 sorted by the personal ID codes like the case when the receiver selects the Internet banking, the host server 10 analyzes the particulars of reception stored in the third data base 13, and provides the receivers with economy data that suggests a direction of economic activity for each receiver. The economy data provided to the receiver is in a form of electronic mail or simple text, which is explained in detail, already. As another example, a charge notice housekeeping book for each receivers may be written up based on the particulars of reception stored in the third data base 13, and give to the receiver, so that the receiver regulates a direction of economic activity with reference to the charge notice housekeeping book.

Moreover, the host server 10 may manage the particulars of the payments stored in the second data base by due dates, to inform a charge notice having a close due date to the receiver, by clicking a list related to the charge notice/charge settlement in various mail lists displayed as shown in FIG. 6, when, of course, an electronic notice of the selected list is provided to the receiver, and alarms that due dates have come or close for the charge particulars stored in the second data base are given to the receiver in an order of due dates, for avoiding the problem of payment delay. The time of alarm giving may be on the due date or a certain days before the due date, which varies with embodiments. To do this, an item showing completion of payment for each of particulars of payment to the receiver is included additionally to the mail list items (reception confirmation, from, subject, data of reception, and viewing the notice) in FIG. 6. That is, as shown in FIG. 8R, since a list of unpaid charge notices is displayed in default limited to the charge notices the receiver applied to an electronic notice service, the list of unpaid charge notices among received charge notices can be viewed, and upon clicking the notice, detailed particulars of the notice can be viewed. Since paying the charge is linked to the screen of the detailed particulars, the charge can be paid as explained before.

For enhancement of reliabilities of the electronic notice service and clearness of identity of the service users, an authentication procedure is provided between each of the parts in the electronic notice system. Through the authentication, the parts are given and hold proper authentication from an authentication organization acknowledged officially, and exchange and verification of the authentication are carried out. Because keys to be used in encryption/decryption of the electronic documents are fixed in the authentication negotiation done by exchange and verification of the authentication, the authentication is essential in the present invention. A method for making access to a web site for issuing notices and transmitting notice data by the notice issuer will be explained. FIGS. 9A˜9I illustrate basic screens required for registration of a notice issuer, and searching a notice data.

Referring to FIG. 9A, when the notice issuer makes access to a web site for issuing charge notices, a screen for inputting data required for registration of notice issuer is displayed, guiding the notice issuer to input a name of the organization of the notice issuer, a postal code and an address, and a person in charge, and to click on ‘registration’, and, when ‘registration’ is clicked, the server gives an ID to the notice issuer. Though, there may be different methods for registration of the notice issuer, a method explained in association with the FIG. 5 is used.

When registration of the notice issuer is completed, a format of charge notice to be sent is selected as shown in FIG. 6B. Kinds of notices the notice issuer can selects differ depending on a type of the notice issuer registered in the notice issuer registration. Upon completion of the foregoing process, the notice issuer transmits data required for producing notices to the service provider in files. That is, as shown in FIG. 9C, the data from the notice issuer is sorted into “notice data” and “receipt data”, and by clicking on “searching for a file”, the file to be transmitted is found, and selected in a local disk. The service provider receives the data, produces notices in a transmittable state, and stores in the second data base 12. Thus, the service provider receives, produces, and stores the data in a transmittable state, verifies consistency of a number of notice data received from the notice issuer and a number of notice data produced, and provides a screen as shown in FIG. 9D to the notice issuer for requesting issuance of the notices, finally. Of course, a searching part is provided on a lower portion of the screen, so that the notice issuer may view detailed particulars of the notice by using the searching part. After the notices are issued to the users (receivers), as shown in FIG. 9E, the notice issuer can view the particulars of the notice send out, already. The viewing is devised to be made by a date of issuance, or by a notice number, and the notice number is hyper-linked to viewing detailed particulars of the notice.

As explained in association with FIG. 8, when the user (receiver) pays the charge through a banking facility, as shown in FIG. 9F, the notice issuer transfers data on the reception of payment from the banking facility to the service provider (host server 10). Of course, when the banking facility is made to provide the data of charge reception both to the notice issuer and the service provider, above process is not required. Upon reception of the payment reception data from the banking facility, after the service provider stores a data in the third data base 13 based on the payment reception data received from the banking facility, the service provider provides a screen for the notice issuer to search for the payment reception data as shown in FIG. 9G. Alikely, as shown in FIG. 9H, the service provider facilitates that the notice issuer can view information on unpaid notices and payers (tax payers). In this instance, the search may be carried out by dates of issue or notice numbers, and the notice numbers may be hyper linked to view detailed particulars of the notices. The service provider provides the notice issuer with information on the client using the notice service. That is, as shown in FIG. 9I, the notice issuer can view information on the client in each notice by inputting a family ID, a social security number or state driver license number, an address, and the like, and the client name may be hyper-linked to view detailed client information on a separate window.

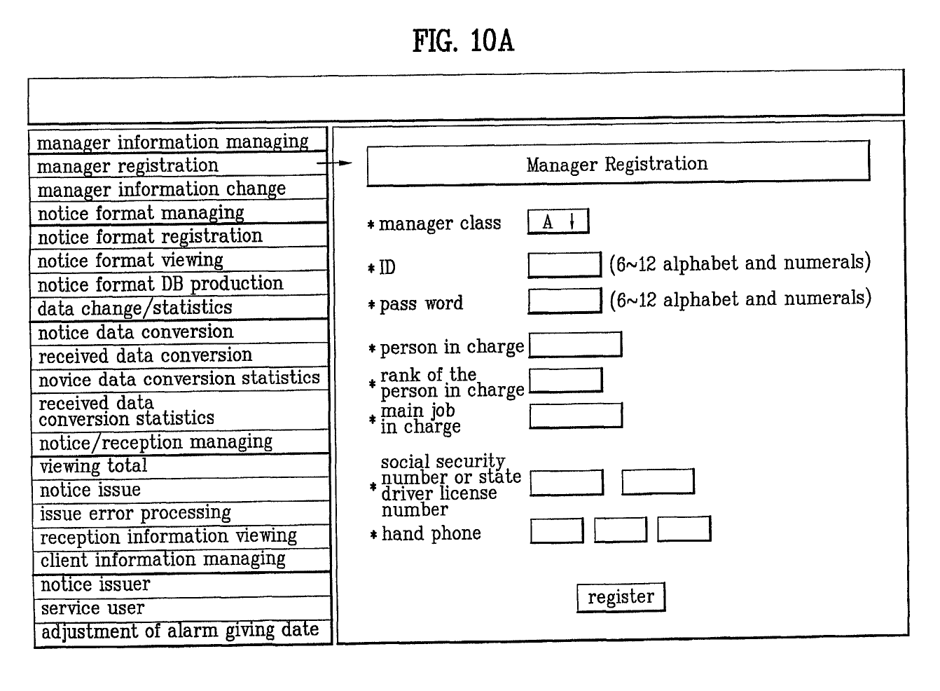

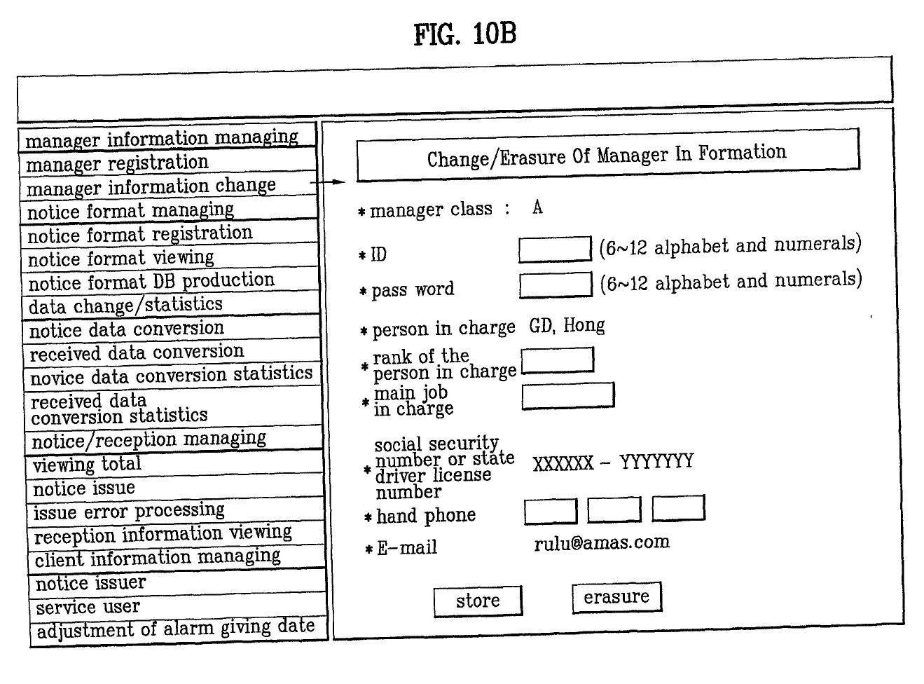

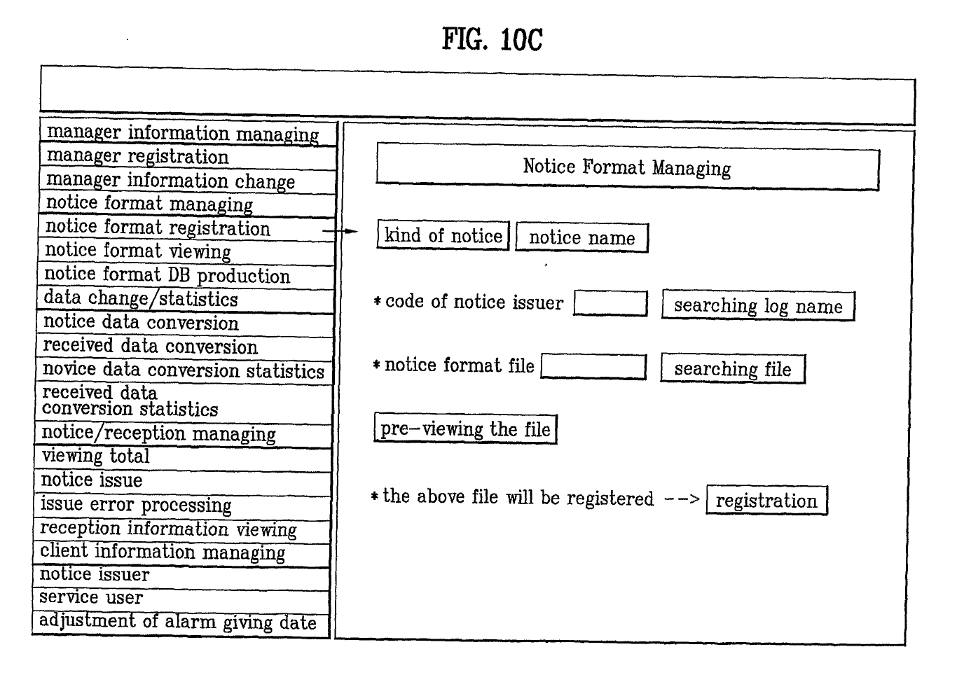

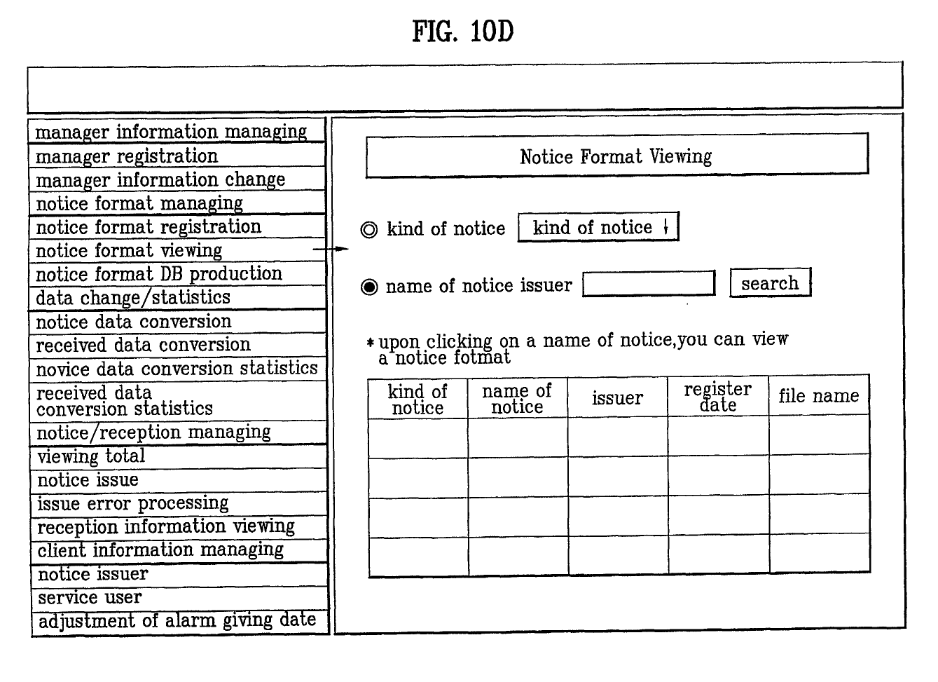

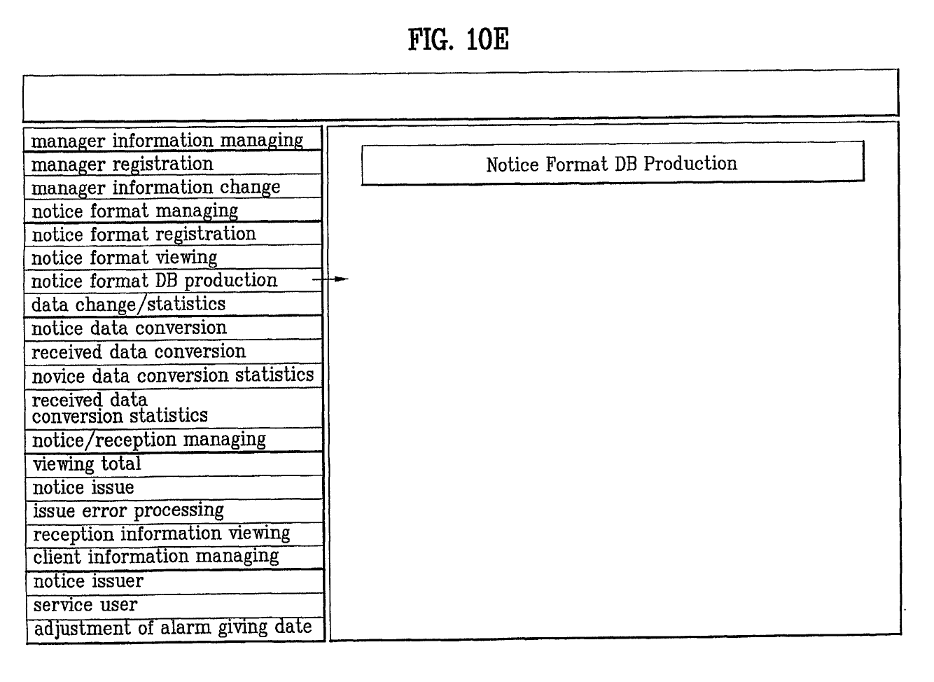

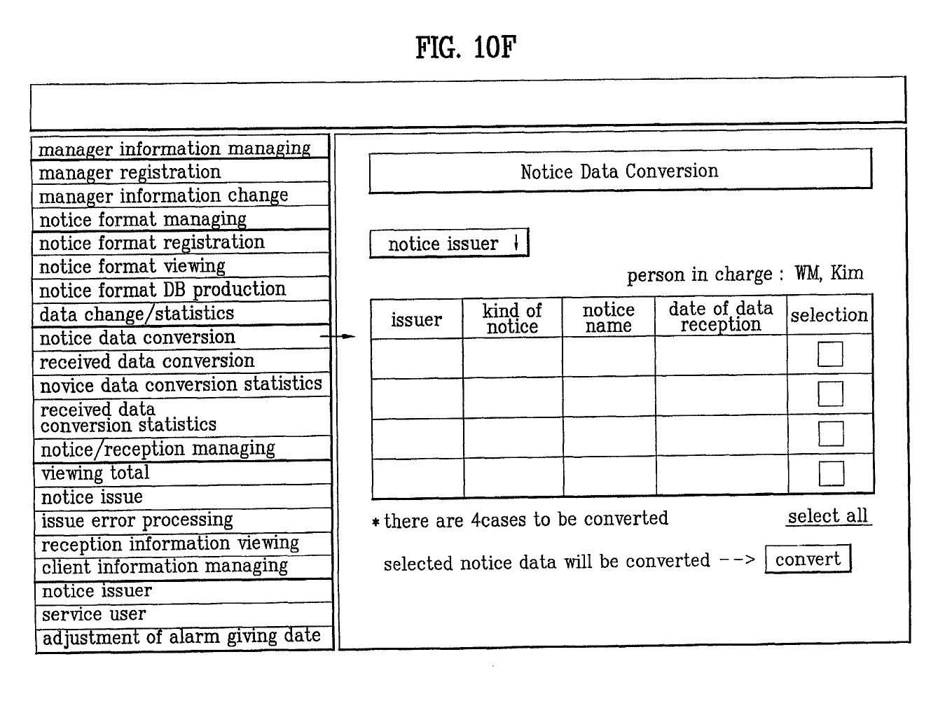

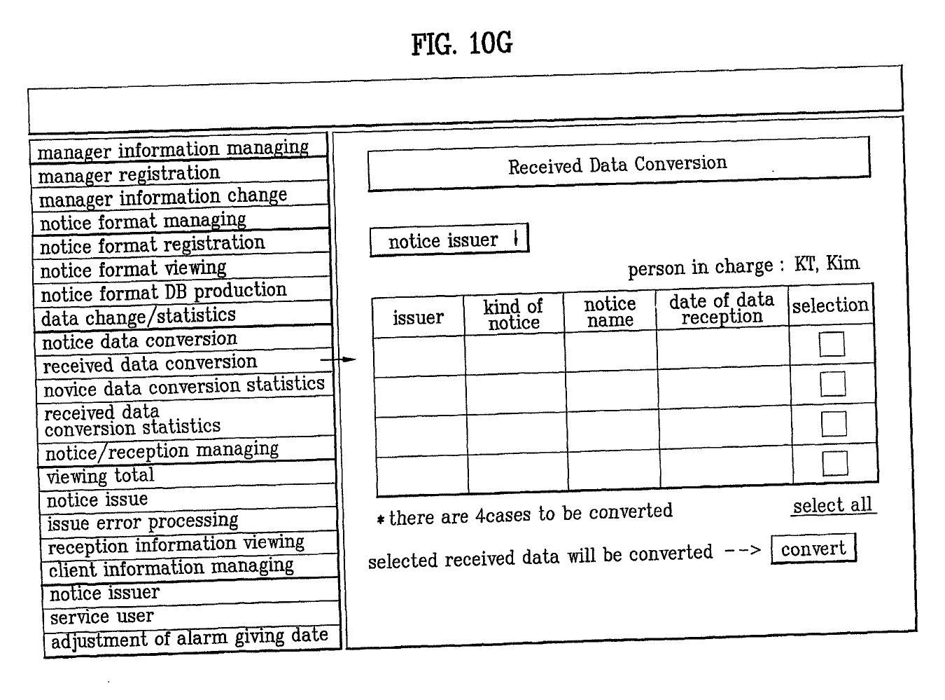

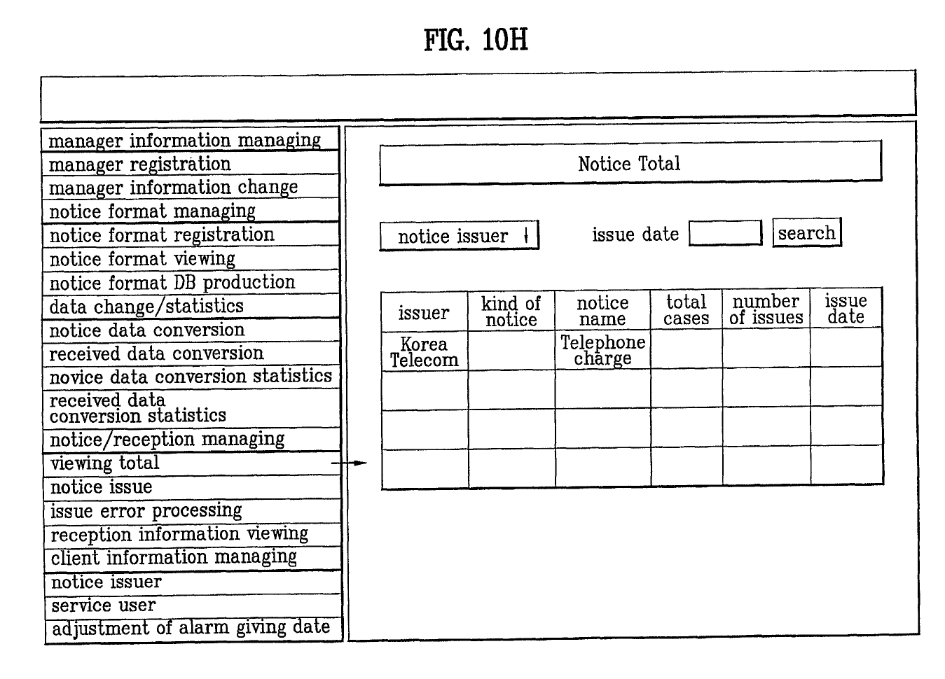

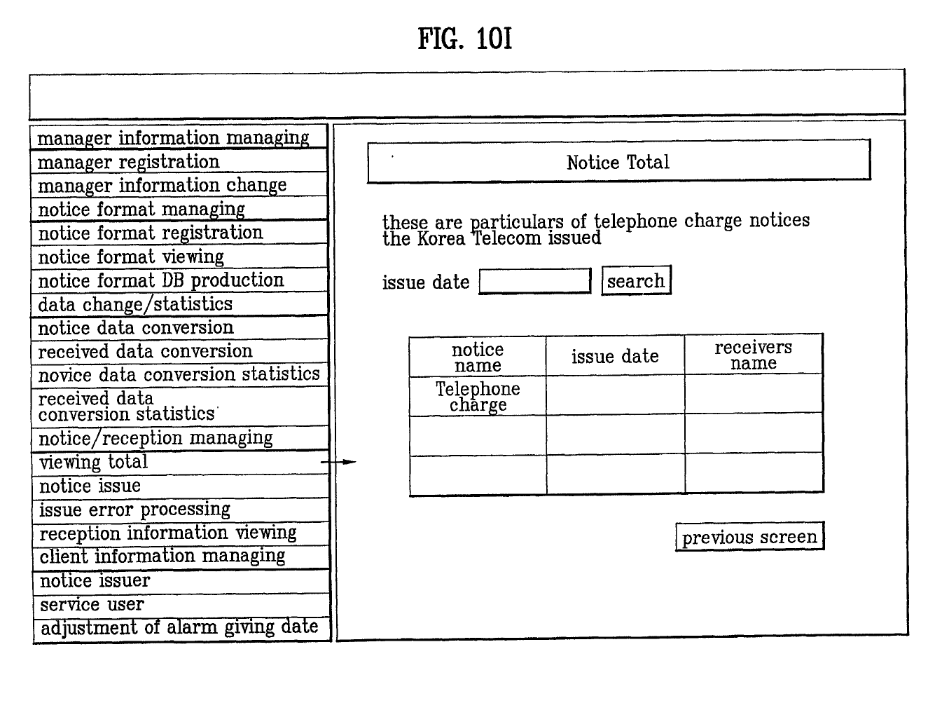

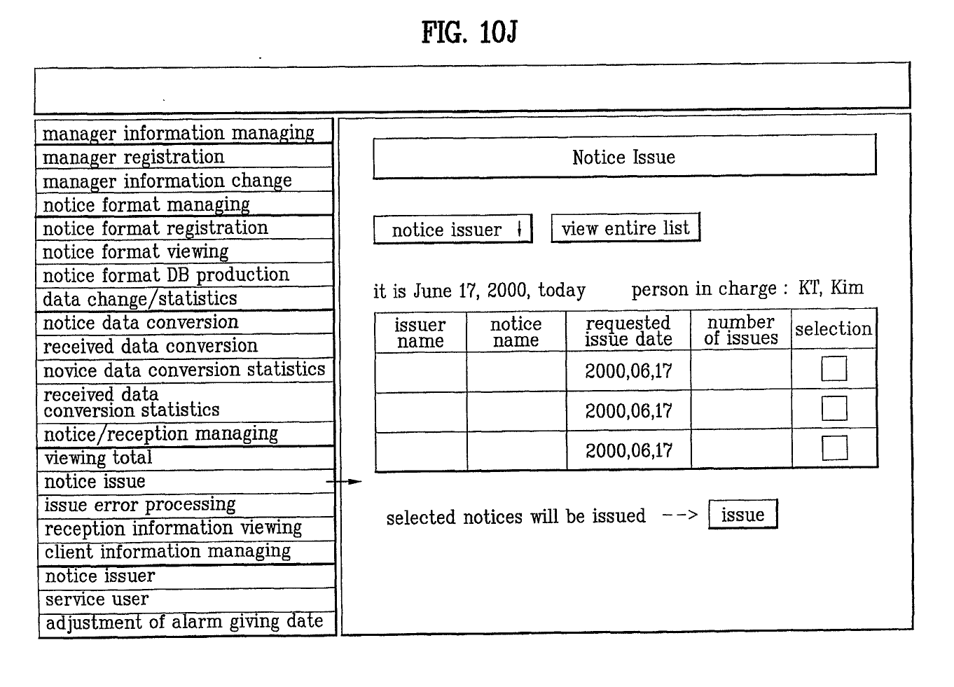

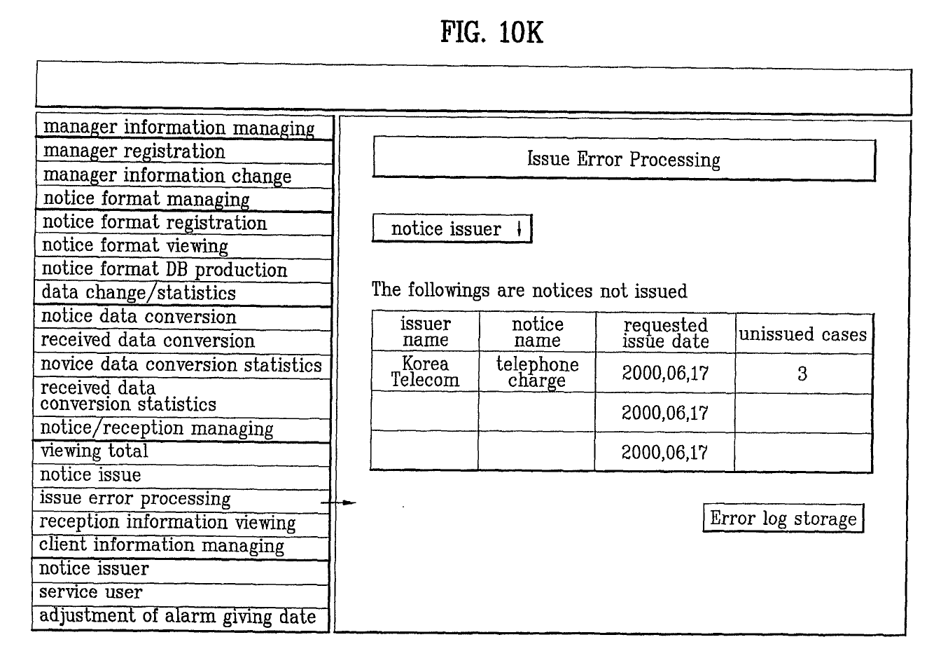

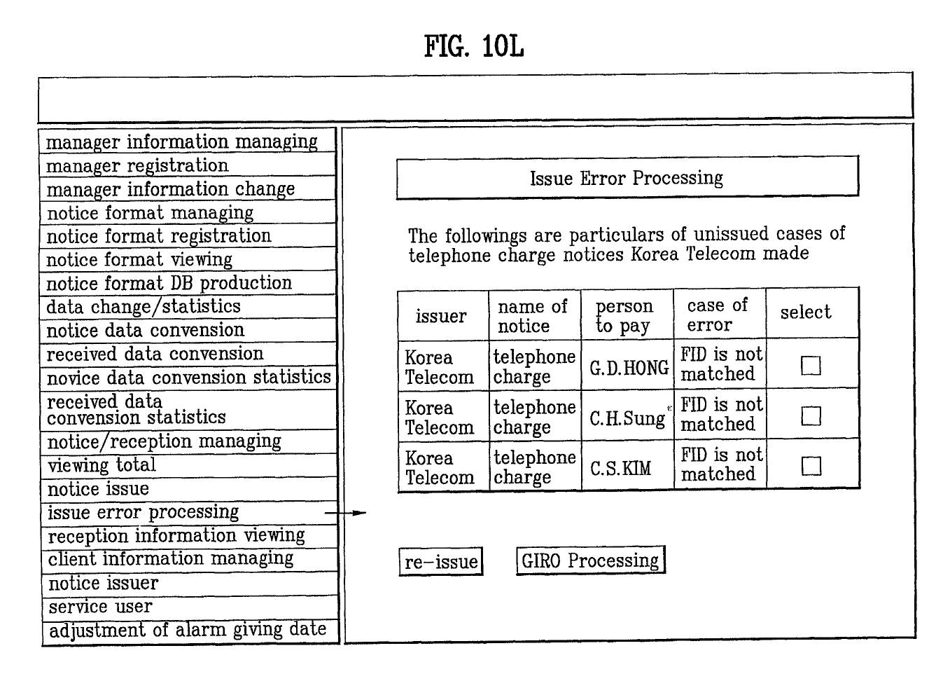

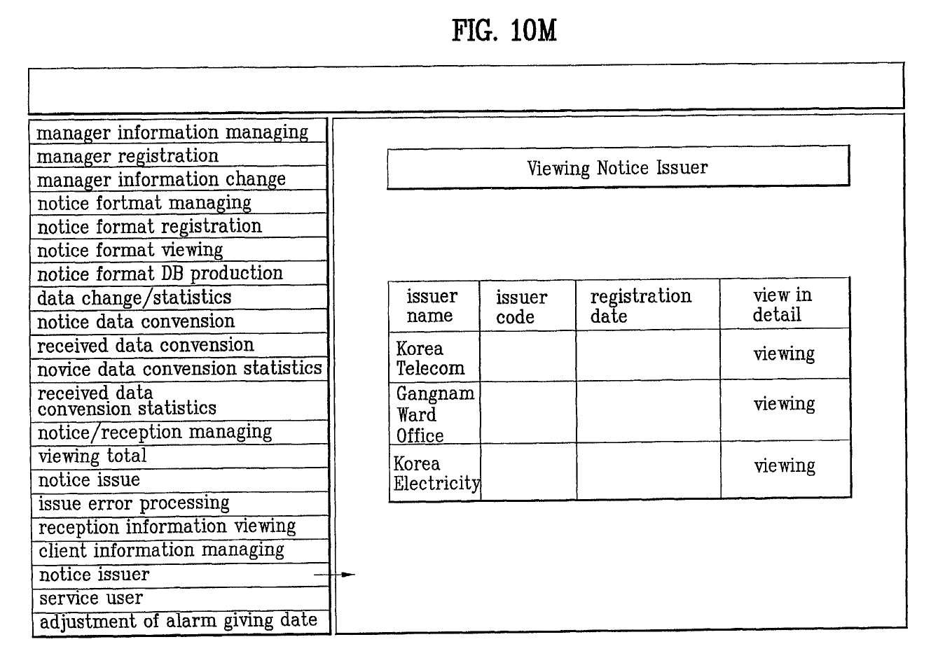

FIGS. 10A˜10O illustrate basic screens required for a service provider to make management and searching in accordance with a preferred embodiment of the present invention. It is made that data revision and management can be made at the host server of the service provider.

Referring to FIGS. 10A and 10B, some employees of the service provider are made to be registered as managers, for, as shown in FIGS. 10C˜10G, registering formats of notices from the notice issuers and producing the formats, and converting and storing notice documents and the reception documents. That is, once the notice data is received from the notice issuer, as shown in FIG. 10C, a notice format file is produced by using a web page editor tool in off-line, separately. Then, as shown in FIG. 10D, it is made possible to search already registered notice formats by kinds of notices and notice issuers. In this instance, when the kinds of notices are selected, the notices are displayed on a table, and the search is made by a name of the notice issuer, a list of notices the issuer issued is displayed. Of course, when the name of the notice displayed thus is hyper linked, a detailed format of the notice can be viewed. Alikely, the service provider receives a data required for issuing notices from the notice issuer in a file and stores the notice data on a relevant notice table in the second data base 12, and receives the payment reception data, which is received from a bank, from a collection organ (notice issuer) in a file and stores on a reception table in the third data base 13. As shown in FIGS. 10H and 10I, the produced notices may be totaled. A number of issues may be checked by notice names for each issuer, or by issue dates, and the notice name may be hyper linked, to refer to particulars of issue of the notice. As shown in FIG. 10J, only notices not issued by default, of which issue date is the day (the day the issuer requests), are displayed, and upon selection of ‘viewing an entire list’, the entire list of the notices can be viewed. Moreover, as shown in FIGS. 10K and 10L, a list of notices not issued owing to inconsistency of users (receivers) ID and social security number or state driver license number, even if the notices are issued, can be viewed, by the notice issuers, and the notice name may be hyper linked, to view detailed list and detailed particulars of the un-issued notices. In this instance, if a giro processing is clicked, it means that the notice is recommended to be processed in giro by the issuer. As shown in FIGS. 10M and 10N, the manager may view/revise/erase information on the notice issuers and view information on the users. Finally, as shown in FIG. 10O, alarms may be set for the issued notices. If the alarm is set from a date before the due date to the due date, the alarm will be issued on the set date.

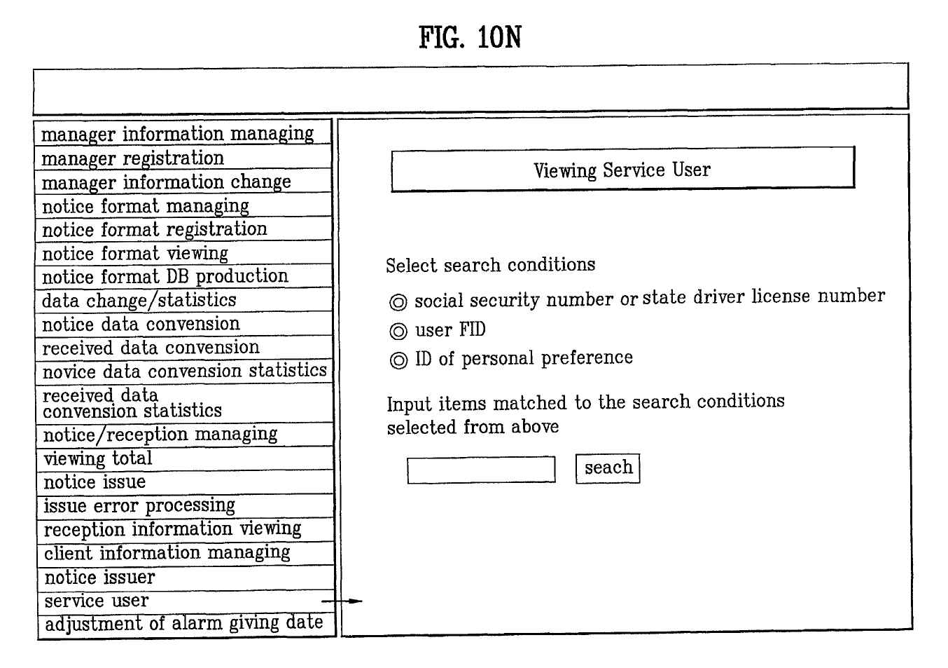

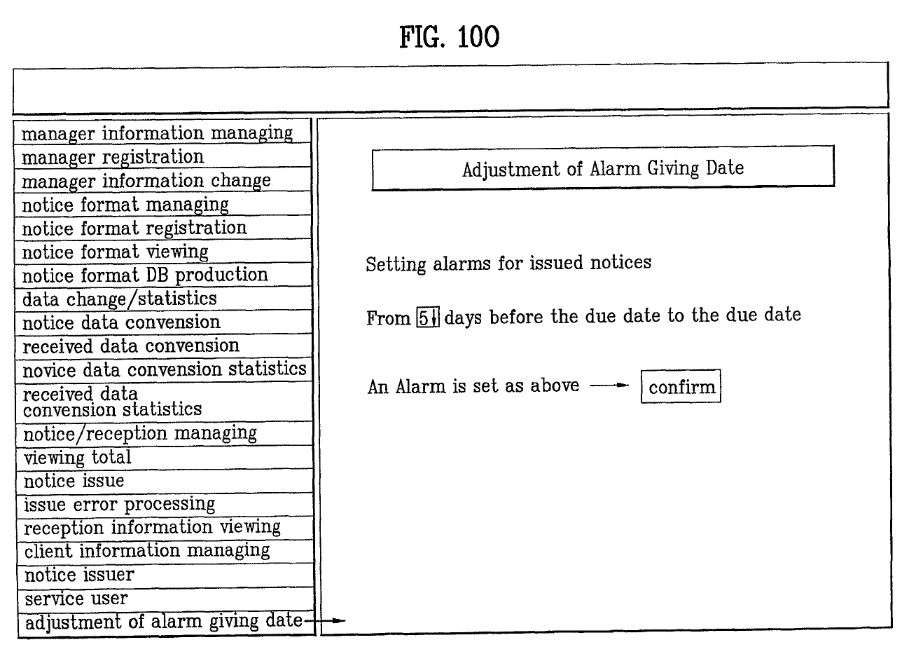

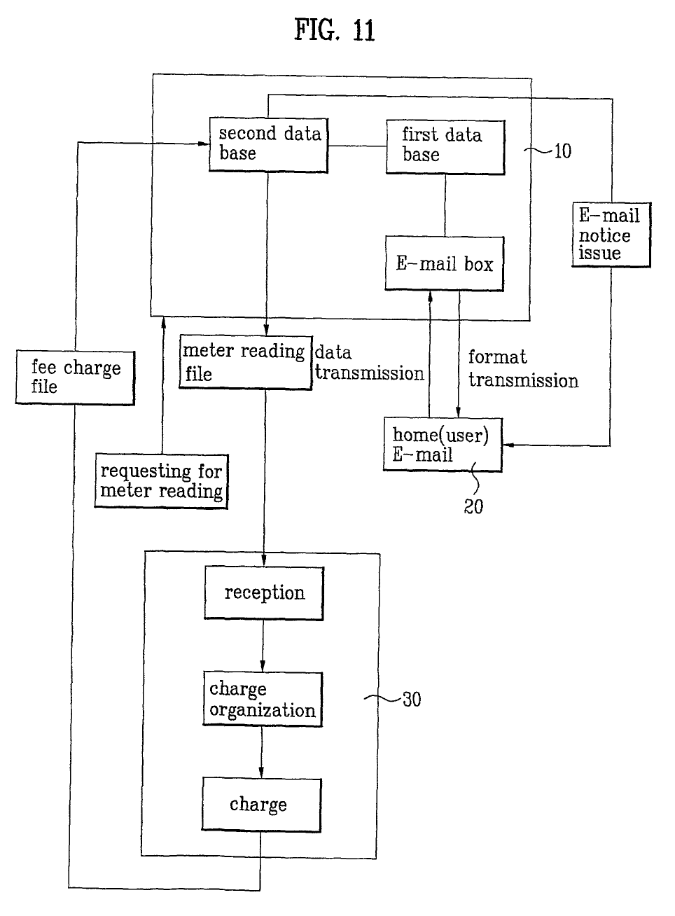

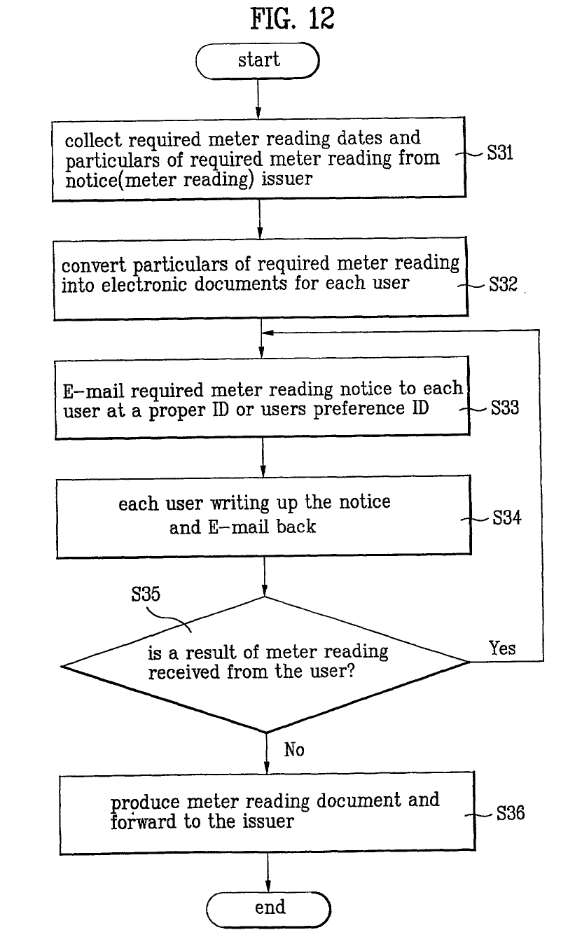

Meantime, a system for reading a meter of city gas, electricity, or city water in each home will be explained. FIG. 11 illustrates a block diagram showing a system for giving an electronic meter reading service in accordance with a preferred embodiment of the present invention, and FIG. 12 illustrates a flow chart showing the steps of operation for giving an electronic meter reading service in accordance with a preferred embodiment of the present invention.

As explained, the service provider has users proper ID codes and ID codes of the users preference stored in the first data base 11, already. That is, it is regarded that the users request for the electronic meter reading services. Therefore, the host server 10 collects agreed meter reading dates and meter reading particulars of the users registered as members from the notice issuers, and stores in the second data base 12 in connection with the users proper ID codes or the ID of users preference stored in the first data base 11, when the agreed meter reading dates and meter reading particulars are stored in the second data base 12 separately for each users (S31). When the agreed meter reading date is due, the host server 10 produces Internet addresses from the users proper ID codes or the users preference ID codes stored in the first data base 11, reads the particulars of meter reading on the agreed date from the second data base 12, and writes up electronic documents (S32). The electronic document may be written up such that, when the user inputs the particulars of the meter reading and clicks “transmission”, the electronic document is transmitted to a mail box of the service provider directly, or a consumption corresponding to fee requested last month is displayed. The service provider transmits the electronic documents (reports of the meter reading) written by using the users ID codes or the users preference ID codes stored in the first data base 11 to each user by E-mail (S33). The user writes the required particulars on the received meter reading notice, and transmits to the service provider (S34). The service provider stores the particulars of the meter reading transmitted from the user in the second data base 12, produces meter reading data for the notice issuers and the particulars of notices separately, and transmits to meter reading data to the notice issuers (S36). In this instance, despite of the transmission of the meter reading notice to the user, if no meter reading particulars are not received from the user within a certain period, the meter reading particulars may be retransmitted, or an average consumption is inputted in producing the meter reading data, and transmitted to the notice issuer (S35). Then, the notice issuer receives the meter reading data thus, calculates a corresponding charge, and makes an electronic notice by a method explained before. Accordingly, since what is required from the user is only the writing the particulars of the meter reading and clicking the transmission button, the meter reading can be made with easy without putting a burden on the user.

As has been explained, the method for producing an ID code, the method for making an electronic notice service, and the system therefor have the following advantages.

First, an electronic document can be provided by using a unitary and permanent ID, and the use of the family ID sorted in terms of address permits to analyze economic activities in view of spending habit and expected expenditure, to permit the economic activities based on prediction, that allows a wholesome management of home (enterprise).

Second, the composition and encryption of the postal code, the address, and the residential number in production of the family ID can prevent the family ID from being utilized in crime.

Third, the notice and payment service for public utility charges and other services provided from various enterprises through a cyber space (particularly, the Internet) provides convenience to the users (receivers).

Fourth, the transmission of notices through the cyber space saves postal expenses of the notice issuers, such as governmental organizations and enterprises, and reduces waste of manpower caused by posting by mailing in view of a country.

Fifth, the charge particulars made into a data base and the suggestion of a direction of economic activity based on the charge particulars permits the receivers (individuals, homes, or corporations) to regulate the economic activity with reference to economic indices provided to them.

Sixth, the conservation of particulars of notices and the particulars of settlement can prevent suffering from damage caused by lost receipt.

Seventh, cost for meter reading manpower can be saved, since the users themselves receive meter reading notices, write meter reading on the notices, and provide written up notices to the service provider, which allows cost reduction of the city gas, electricity, and city water.

It will be apparent to those skilled in the art that various modifications and variations can be made in the method for producing an ID code, the method for making an electronic notice service, and the system therefor of the present invention without departing from the spirit or scope of the invention. Thus, it is intended that the present invention cover the modifications and variations of this invention provided they come within the scope of the appended claims and their equivalents.

1. A system for producing an identification (ID) code comprising:
an arbitrating part for interfacing and arbitrating a plurality of users and business connections in information exchange;
an ID producing part for producing a family ID made distinctive for each address by using user information received through the arbitrating part or stored already;
a storage part for storing data to be provided to members by using information on business connections received through the arbitrating part;
a member DB for providing and storing a data base of members and data for each member in correspondence to the ID producing part and the storing part; and,
a controlling part for managing and controlling the entire system.

2. A method for producing an ID code, comprising the steps of:
(1) receiving required information on a user through Internet or information stored in a storage part already;
(2) producing IDs identifiable by addresses from numerals or codes used generally, universally, and socially in the received information by using ID codes fixed in advance; and,
(3) providing the produced ID to the user.

3. A method as claimed in claim 2, wherein the step (2) includes the steps of;
(2-1) a member providing member information to a service provider, or providing user information stored in the storage part to an ID producing part through an arbitrating part,
(2-2) detecting required information sorted by addresses received at the ID producing part, and converting into codes and numerals by using codes defined in advance, and
(2-3) combining the required information converted into codes and numerals, to produce a family ID.

4. A method as claimed in claim 3, wherein the required information is producing an ID code for each address from at least one selected from a postal code and actual address, a telephone number, an enterprise registration number, and a social security number, or state driver license number.

5. A method as claimed in claim 3, wherein the step (2-3) further includes the step of adding another code to the produced family ID to combine the family ID and the another code, to produce personal ID for a plurality of members of the family or the enterprise.

6. A method as claimed in claim 2, wherein the step (3) includes the steps of adding an advertisement to the E-mail in providing the E-mail to the user.

7. A method as claimed in claim 2, wherein the step (2) includes the steps of;
(2-1) detecting users postal code and an actual address,
(2-2) coding the postal code into at least two digits of code by combining alphabet and numerals,
(2-3) coding a numerical portion of the address excluding down to a village name, and
(2-4) combining codes of the postal code and the actual address, to produce the family ID.

8. A method as claimed in claim 7, wherein, if there are different apartments within the same postal code, different codes are given to apartments.

9. A method as claimed in claim 2, wherein the step (2) includes the steps of;
(2-1) detecting a users telephone number,
(2-2) coding an area code or a mobile communication company code of the telephone number into a code with at least one digit, and
(2-3) combining numerals of the telephone number, excluding the area code or the mobile communication company code of the telephone number, with the code from the area code, to produce the family ID.

10. A method as claimed in claim 2, wherein the step (2) includes the steps of;
(2-1) detecting an enterprise registration number of an enterprise, having codes of an area, a tax office, a form of the enterprise, and a serial number,
(2-2) coding the codes of the area and the tax office into a code with at least one digit,
(2-3) coding the code of the form of the enterprise into a code with at least one digit, and
(2-4) combining the produced codes and the serial number to produce the family ID.

11. A method as claimed in claim 2, wherein the step (2) includes the steps of;
(2-1) detecting users postal code, an actual address, and a social security number, or state driver license number,
(2-2) coding the postal code into a code with at least two digits,
(2-3) coding a numerical portion of the address into a code with at least digits excluding village/town/township,
(2-4) coding the social security number or state driver license number into a code with at least two digits, and
(2-4) combining the produced codes, to produce the family ID.

12. A method as claimed in claim 11, further including the steps of;
coding each member of a household into a code with at least one digit, and combining the code of the member with the produced codes, to produce the family ID.

13. A method as claimed in claim 11, further including the steps of;
adding another one digit of data in the coding for verification.

14. A method as claimed in claim 2, farther comprising the steps of;
(4) providing the produced ID to the user, and letting the user to input an ID of preference; and,
(5) managing the ID of the users preference and the produced ID in common, for transmission/reception of a data by the ID of the users preference and the produced ID.

15. A method for giving an electronic notice service comprising the steps of:
(1) securing users as members, and producing proper ID codes from users information;
(2) collecting particulars of charges of a plurality of the users (receivers) from various notice issuers;
(3) calculating collected one or more of the particulars of the charges to built up a data base by receivers/due dates;
(4) producing individual charge notice for the user (receiver) in an electronic document based on the data base; and,
(5) transmitting the electronic document to the user (receiver) at the proper ID code.

16. A method as claimed in claim 15, after the step (5), further comprising the steps of:
(6) as the electronic document is displayed on a computer of the user (receiver), the receiver viewing the charge notice and paying the charge;
(7) sorting particulars of reception for the particulars of the charge notice by ID codes, to build up a data base;
(8) analyzing the data base, and providing a housekeeping book to each user (receiver) as an economy data for each user (receiver).

17. A method as claimed in claim 15, wherein, in the step (2), the user selecting items of charge notices to be given as membership registration and authentication of the user (receiver) are completed successfully before the collection, and particulars of charge notices for the users (receivers) are collected from the notice issuers who issue charge notices for the selected items.

18. A method as claimed in claim 15, wherein the step (5) includes the steps of;
producing individual charge notice in a form of electronic document of an electronic mail, and
transmitting the electronic document to an individual Internet address produced from the individual ID code.

19. A method as claimed in claim 15, wherein, receiving an ID of users preference instead of the proper ID code from the users information, and transmitting the produced electronic document to the proper ID code or the ID code of the users preference.

20. A system for an electronic notice comprising:
a first data base for storing a proper ID code of a user produced from users information;
a second data base for storing one or more charge particulars for each user (receiver) collected from various notice issuers, with the charge particulars separated by ID codes in connection with the ID codes stored in the first data base;
a host server for producing Internet address for each user (receiver) from the ID code stored in the first data base, producing charge particulars to the ID code stored in the second data base in an electronic document, and transmitting the electronic document to the Internet address; and,
a users computer for restoring charge notice particulars from the electronic document transmitted from the host server, and displaying the charge notice particulars to the user (receiver) given an ID code corresponding to the Internet address.

21. A system as claimed in claim 20, wherein the host server processes payments in a payment method fixed in advance by the receiver in connection with a banking facility fixed in advance as the receiver confirms the displayed charge notice particulars, and approves the payment.

22. A system as claimed in claim 20, further comprising a third data base for storing reception particulars after the charge is paid as the receiver approves payment for the charge notice, with the reception particulars separated by ID codes in connection with the ID codes stored in the first data base.

23. A system as claimed in claim 20, wherein the host server analyzes payment reception particulars stored in the third data base, and provide the receiver with a text for suggesting the receiver a direction of economic activity.

24. A method for giving an electronic meter reading service, comprising the steps of:
(1) securing a plurality of users as members, and producing proper ID codes from users information;
(2) collecting agreed meter reading dates and agreed meter reading particulars for a plurality of the users registered as members from various meter reading notice issuers, and building up a data base;
(3) producing meter reading notice for the user in an electronic document based on the data base; and,
(4) transmitting the electronic document to the user at the ID code.

25. A method as claimed in claim 24, further comprising the steps of:
(5) after the electronic document is transmitted to the user, the user writing meter reading particulars on the electronic document, providing to the service provider; and,
(6) the service provider producing meter reading documents by notice issuers, and notice items by using the meter reading particulars from the user, and transmitting the produced meter reading documents to the notice issuers.

26. A method as claimed in claim 25, if no meter reading is received from the user within a due date despite of sending a meter reading notice to the user, further including the step of;
re-transmitting the meter reading notice to the user or producing a meter reading document by writing an average consumption, and transmitting the meter reading document to the notice issuer.

27. A method as claimed in claim 24, wherein receiving an ID of the users preference instead of the proper ID code from the users information, and the produced electronic document is transmitted to the proper ID code or the ID code of the users preference.

28. A method as claimed in claim 24, wherein the electronic document is formed such that the user inputs meter reading particulars, and clicks on a send window on the electronic document, to transmit the electronic document, instantly.
